(19) United States
(12) Patent Application Publication
(10) Pub. No.: US 2009/0091566 A1
(43) Pub. Date: Apr. 9, 2009

(54) System and methods for thick specimen imaging using a microscope based tissue sectioning device

(76) Inventors: Stephen G. Turney, Newton, MA (US); Philip W. Sheard, Dunedin (NZ)

Correspondence Address: WOLF GREENFIELD & SACKS, P.C., 600 ATLANTIC AVENUE, BOSTON, MA, 02210-2206, US

(21) Appl. No.: 11/973,272

(22) Filed: Oct. 5, 2007

(51) Int. Cl. G06T 15/00; G06K 9/00

(52) U.S. Cl. 345/419; 382/128

(57) ABSTRACT

Systems and methods according to embodiments of the present invention facilitate imaging and sectioning of a thick specimen that allow for 3D image reconstruction. An example embodiment employs a laser scanning microscope and sectioning device, where the specimen, and optionally, the sectioning device are affixed to respective programmable stages. The stage normally used for aligning the specimen with the microscope objective is used as an integral component for sectioning the specimen. A specimen is imaged such that the imaging depth is less than the sectioning depth to produce overlap in contiguous sets of images; both acts are repeated until the imaging is completed. A substantially or completely seamless 3D image of the specimen is reconstructed by collecting sets of 2D images and aligning imaged features of structures in overlapping images or portions thereof. Specimen may be from a human, animal, or plant.

### INCORPORATION BY REFERENCE OF MATERIAL ON COMPACT DISK

This application incorporates by reference three-dimensional (3D) images in the form of movies in .wmv format contained on compact disks filed concurrently herewith. Each compact disk is being filed in duplicate. The 3D images represent specimens upon which extended-depth confocal microscopy has been employed in accordance with an example embodiment of the present invention. The specimens are transgenic mouse tissue specimens imaged with high spatial resolutions and at significant depths and volumes.

The following files are contained on the compact discs:
a) File name: Occipital-Lobe-320×320×360 um-sections.wmv; created May 18, 2007, 3.60 MB in size. (3D reconstruction of 1×1×12 overlapping stacks, sectioning every 25 microns; blue=cfp, green=yfp, red=dsRed)
b) File name: Frontal-Lobe-1.9×1.3×65 mmsectioning-80 um.wmv; created May 16, 2007, 4.34 MB in size. (3D reconstruction of 3×2×9 overlapping stacks, sectioning every 80 microns)
c) File name: Frontal-Lobe-0.635 mm×0.635 mm.wmv; created Aug. 14, 2007, 5.81 MB in size. (3D reconstruction of 1×1×25 overlapping stacks, sectioning every 80 microns, 1.4 mm deep)
d) File name: Frontal-Lobe-1.3 mm×1.3 mm.wmv; created May 13, 2007, 3.85 MB in size. (3D reconstruction of 2×2×8 overlapping stacks, sectioning every 60 microns)
e) File name: Extensor-digitoris-stack.wmv; created May 51, 2007, 4.12 MB in size. (composite stack of 1×1×6 overlapping stacks, sectioning every 80 microns, green=yfp-filled axons, red=dsRed-filled Type IIA muscle fibers)
f) File name: Confocal-vs-SATIS-stack.wmv; May 4, 2007, 1.71 MB in size. (3D reconstruction of 1×1×5 overlapping stacks, sectioning every 80 microns; 300 microns deep, red=SATIS stack, green=confocal microscope stack)

To view the images, one must use Microsoft Windows Media Player, version 10 or equivalent.

### BACKGROUND OF THE INVENTION

Ever since van Leeuwenhoek developed the first microscope nearly 400 years ago, scientists have wanted to use a microscope to view the fine details of complex structures. However, microscopes can generally reveal structures only at or near the surface of specimens. The ability to observe below the surface of a specimen has remained limited but possible, to some extent, by an ability of an histologist to slice the specimen into thin slices, thereby bringing deep structures to the surface. In so doing, precise spatial relationships between structures within the slices are altered making it difficult or impossible to describe these relationships within the intact specimen. The 1980's brought the confocal microscope and the ability to image specimens emitting fluorescent light up to 100 microns deep. This was followed in the 1990's by two-photon microscopy, which extended the range to 300 microns. An advanced and expensive application of two-photon microscopy allows imaging up to 1 mm, but light scattering still limits the resolution at which structures may be viewed. Light scattering may thereby eliminate the ability to resolve fine structures, such as cellular details. Ultimately, it is cellular details that are of most interest to microscopists.

### SUMMARY OF THE INVENTION

The summary that follows describes some of the example embodiments included in this disclosure. The information is proffered to provide a fundamental level of comprehension of aspects of this disclosure.

An example embodiment of the present invention includes a system and corresponding method for generating a three-dimensional image of a specimen comprising: an objective, optical elements, a sectioning device, a programmable stage, a programmable focus controller, and a sensor. The objective may be spaced a distance from the specimen at which at least part of the specimen is within the in-focus plane of the objective. The optical elements may direct incident light from a light source along an incident light path to multiple regions of the in-focus plane of the objective. Directing light to the multiple regions and the emitted light may include separate beams of emitted light corresponding to the specimen portions. Directing light may also include serially directing incident light to each region to illuminate separately each specimen portion within a corresponding one of the regions, which may include scanning the specimen with the incident light to sequentially illuminate separate portions of the specimen. The multiple regions of the in-focus plane of the objective may have a thickness substantially equal to a depth of field of the objective. The incident light may cause the specimen, at the in-focus plane, to produce emitted light responsive to the incident light. The optical elements may also direct the emitted light along a return light path.

The sectioning device may be configured to section the specimen. The programmable stage may be in an operative arrangement with the objective and sectioning device and configured to support and move the specimen. The specimen may be moved to the objective to image at least one area of the specimen and relative to the sectioning device to section the specimen in a cooperative manner with the sectioning device. The programmable focus controller may change the distance between the objective and programmable stage to move the in-focus plane of the objective within the specimen. The sensor may be in optical communication with the return light path to detect the emitted light from the multiple regions of the in-focus plane of the objective and to generate signals representative of detected emitted light.

The programmable stage (stage) may reposition the specimen relative to the objective to bring an area of the specimen previously outside the field of view of the objective to within the field of view of the objective. The stage may position the specimen relative to the objective to produce partial overlap between three-dimensional images of contiguous areas of the specimen in at least one of two perpendicular dimensions. The partial overlap may be in the X-axis or Y-axis.

Another example embodiment of the system and method may further include a programmable focus controller to change the distance between the stage and the sectioning device to define how much depth of the specimen is to be sectioned, which may be less than the imaging depth to produce partial overlap in contiguous three-dimensional images of the same field of view before and after sectioning. The programmable focus controller may also move the objective relative to the stage, or vice versa, to change the distance between the objective and specimen to bring more portions of the specimen within the in-focus plane of the objective.

The system and method may include an image and sectioning tracker to determine a distance and tilt between the in-focus plane of the objective and a sectioning plane of the sectioning device to support accurate imaging and sectioning. The image and sectioning tracker may also determine the position of the surface of the specimen after sectioning to use as a reference in a next imaging and sectioning.

The system and method may further include an imaging controller configured to cause the objective to image contiguous areas of the specimen with partial overlap and to cause the programmable stage to move in a cooperative manner with the sectioning device to section the specimen between imaging of the contiguous areas. The imaging controller may also cause the programmable stage to repeat the imaging and sectioning a multiple number of times. The contiguous areas are contiguous in the X-, Y- or Z-axis relative to the objective.

The system and method may further include a reconstruction unit, an identification unit, a feature matching unit, an offset calculation unit, and a processing unit. The reconstruction unit may be used to reconstruct multiple three-dimensional images based upon multiple sets of two-dimensional images based on signals representative of the detected light. The identification unit may identify features in the multiple three-dimensional images. The feature matching unit may determine matching features in contiguous three-dimensional images. The offset calculation unit may calculate offsets of the matching features to generate an alignment vector or matrix. The processing unit may process the contiguous three-dimensional images as a function of the alignment vectors or matrix to generate adjusted data representing an adjusted three-dimensional image.

The system and method may further include a display unit to display the adjusted three-dimensional image.

The system and method may further include a transmit unit to transmit data, representing two-dimensional images, representing layers of the specimen within the imaging depth of the objective, via a network to a reconstruction server to reconstruct a three-dimensional image of the specimen at a location in the network apart from the sensor. A data storage unit may also be used to store data representing the two-dimensional or three-dimensional images.

The system and method may further include an imaging controller configured to cause the programmable stage to move the specimen to the sectioning device or to cause a different programmable stage, in operative relationship with the sectioning device, to move the sectioning device to the specimen.

The system and method may further include a storage container and a reporting unit. The storage container may store sections removed from the specimen to enable a person or machine to identify aspects of the sections and generate a correlation of the aspects of the sections with images representing layers in the specimen. The reporting unit may report results of the correlation. The system may also include a staining unit to enable the person or machine to stain the sections removed from the specimen to correlate the sections stored with the respective images of the sections.

In an example embodiment of the present invention, the sectioning device oscillates a blade relative to a blade holder in a substantially uni-dimensional manner.

In accordance with the present invention, the objective and programmable stage are components of a microscope selected from a group consisting of: an epifluorescence microscope, confocal microscope, or multi-photon microscope. Additionally, the sensor may detect fluorescent light emitted by the specimen at select wavelengths of a spectrum of the emitted light. The sensor may also include a detector selected from a group consisting of: a photo-multiplier tube (PMT) or a solid-state detector, such as a photo-diode or a charge-coupled device (CCD) array. The “specimen” may be tissue selected from a group consisting of: a human, animal, or plant.

Another example embodiment of the present invention includes a method for providing data for healthcare comprising: generating a three-dimensional image of a specimen from a patient by reconstructing multiple two-dimensional images of layers of the specimen and transmitting data representing the three-dimensional image via a network to the patient or a person associated with the healthcare for the patient. The “patient” may be a human, animal, or plant.

### BRIEF DESCRIPTION OF THE DRAWINGS

The patent or application file contains at least one drawing executed in color. Copies of this patent or patent application publication with color drawing(s) will be provided by the Office upon request and payment of the necessary fee.

The foregoing will be apparent from the following more particular description of example embodiments of the invention, as illustrated in the accompanying drawings in which like reference characters refer to the same parts throughout the different views. The drawings are not necessarily to scale, emphasis instead being placed upon illustrating embodiments of the present invention.

FIG. 1 is a drawing of a laser scanning microscope system suitably configured to generate high-resolution three-dimensional images of thick specimens in accordance with an example embodiment of the present invention;

FIGS. 2A and 2B illustrate a process by which high-resolution imaging and sectioning of a large tissue is done in accordance with an example embodiment of the present invention;

FIGS. 3A and 3B are schematic diagrams illustrating example three-dimensional reconstructions of a specimen imaged in accordance with an example embodiment of the present invention;

FIGS. 4A-4C illustrate a comparison of imaging of thick specimens using confocal microscopy, in contrast to imaging using extended-depth confocal microscopy in accordance with an example embodiment of the present invention;

FIG. 5 depicts a three-dimensional reconstruction of the distribution of principal neurons in the frontal lobe of a transgenic mouse expressing yellow fluorescent protein under the CD90 cell surface protein promoter as done using an example embodiment of the present invention;

FIG. 6 is a schematic diagram providing detail of another example of a laser scanning microscope system suitably configured for generating high resolution images of a specimen in accordance with an example embodiment of the present invention;

FIGS. 7A and 7B are diagrams of a microscope-stage specimen bath that may be used in accordance with the present invention;

FIGS. 8A-8C are schematic diagrams of front, top, and side views of a blade holder that may be used in a blade assembly in accordance with an example embodiment of the present invention;

FIGS. 9A-9D are schematic diagrams of a blade holder coupled to a manipulator that may be used in accordance with the present invention;

FIG. 10A is a diagram illustrating the use of an example embodiment of the present invention to provide data for healthcare providers;

FIG. 10B is a network diagram illustrating a computer network or similar digital processing environment in which the present invention may be implemented;

FIG. 10C is a diagram of the internal structure of a computer in the computer system of FIG. 10B;

FIGS. 11A-11D illustrate an example embodiment of the present invention configured for generating a high-resolution three-dimensional image of a thick specimen; and

FIGS. 12A and 12B are block diagrams illustrating an exemplary method that may be employed in accordance with the present invention.

### DETAILED DESCRIPTION OF THE INVENTION

A description of example embodiments of the invention follows.

Investigations into the mechanisms underlying neural development, such as growth and differentiation, are enhanced by an ability to develop images of neural structure at a microscopic level. To label cells selectively, neuronal tracers can be injected at specific sites in the nervous system. In addition, transgenic mice are available that express fluorescent proteins in subsets of neurons. Techniques for imaging fluorescent structures in thick specimens include confocal and multi-photon microscopy; however, light scattering limits the depth at which signals can be acquired with high resolution. Electron microscopy and standard histology techniques overcome the limitations due to light scattering. Nevertheless, these techniques are not commonly used to reconstruct images of structures in thick specimens because of the difficulty of collecting, aligning, and segmenting serial sections. A need remains for improved techniques to image three-dimensional cellular structures in thick specimens.

Further, current techniques for imaging a large tissue volume rely largely on use of a tissue slicing device to render the volume into thin slices, each of which can be imaged separately. Imaging thin slices is necessary using current techniques because, as mentioned above, the light used to generate the image penetrates only a short distance into a specimen; therefore, structures located below the specimen surface cannot be visualized until they are brought to the surface by removal of structures above the structures of interest. Images from each thin slice may then be reconstructed into a three-dimensional volume using computer applications. A problem with such techniques is that, on sectioning the specimen, the resulting slice can be significantly distorted, leaving the images of such slices with no consistent spatial relationship to one-another and rendering three-dimensional reconstruction of the volume difficult or impossible, if the structure is complex, and three-dimensional reconstructions may be inaccurate or incomplete if the structure is able to be rendered.

Described herein are example embodiments of a system and corresponding method that are designed to facilitate imaging and sectioning (e.g., slicing) of large volumes of biological tissue specimens in a way that allows for seamless three-dimensional reconstruction of the tissue volume. Reconstruction of large tissue volumes is of value and interest to scientists, for example, to increase understanding of spatial relationships and prospects for functional interaction between cells and their processes. Example embodiments of the present invention are of major significance because they allow scientists to understand the organization of large numbers of cells in their natural configuration, and an ability to perform high resolution spatial mapping of large three-dimensional tissue volumes provided by the example embodiments.

Embodiments of the present invention described herein address shortcomings of current techniques used to generate three-dimensional images of structures in a thick specimen by providing a novel approach to developing images of thick specimens using a combination of a laser scanning microscope system and a sectioning device. The approach is based on block face imaging of a specimen. An example embodiment of the present invention is based on a development of a miniature microtome and the use of precision programmable stages to move the specimen relative to the microtome or vice versa and realign the specimen with respect to an imaging system. Imaging through use of the example embodiment or other example embodiments as presented herein is flexible and promises to be useful in basic research investigations of synaptic connectivity and projection pathways and also useful in other contexts, such as hospitals, physician offices, pathology laboratories, central diagnostic facilities, and so forth. Images of specimen fluorescence may be developed at the resolution limit of a light microscope using very high Numerical Aperture (NA) objectives. A system and method according to example embodiments of the present invention may also be used to reconstruct images of cellular structures in different organs, for example, muscle and liver.

An example embodiment of the present invention overcomes problems due to sectioning (e.g., slicing) specimens by imaging tissue of interest (also referred to herein as “sections”) before it is sectioned. By doing so, all structures within the tissue retain their original spatial relationship with one another. After imaging into the volume of the tissue of interest, a slice may be removed from the top (i.e., imaging side of the tissue of interest) that is physically thinner than the depth of tissue that was imaged. The slice may be discarded or put through a staining process whose results may then be compared to an image of the slice. The newly exposed tissue surface may then be re-imaged and, subsequently, another tissue section may be taken off the top. Three-dimensional reconstruction of the large tissue volume is possible in this circumstance because: a) the tissue block face is much less prone to distortion due to sectioning, so adjacent structures retain their original spatial relationship to one another and alignment of adjacent series of images can be performed, and b) sets of images are effectively “thicker” than the tissue slice removed, so adjacent sets of images overlap one-another and edge structures appear in adjacent image series. Because edge structures appear in adjacent image series, alignment and reconstruction of the tissue volume can be performed. Additionally, an example embodiment of the present invention may be employed using existing microscope systems. An example embodiment of the present invention does not require that the specimen be cleared, meaning the specimen is not subjected to a process to dehydrate the specimen by replacing water with a polar solvent in the specimen. Hence, the specimen may be imaged in its natural configuration.

Example embodiments of a system or method in accordance with of the present invention enable high resolution three-dimensional imaging and reconstruction of specimens having small or large volumes, where the actual volume that can be imaged is limited only by the size of the structure that can be mounted for sectioning and by computer power and memory for imaging and reconstruction.

Examples of specimen include biological specimens of interest, such as animal or human brain (or part thereof) or skeletal muscle (or part thereof). The system and methods may be used on any soft tissue or structure that can be sectioned and imaged, including most animal or human tissues and organs and also plant “tissues.”

Information gleaned from rendered three-dimensional images may be used to gain new insight into spatial relationships between component cells of the tissue of interest and can thereby promote a new and deeper understanding of the way in which cells interact to produce a functional system. A system and method of the present invention may be used in a research laboratory to provide information on the organization of normal cell systems in a controlled environment and also allow for an investigation of cell organization in pathological or abnormal situations in research animals or in tissues surgically removed from animals or humans for subsequent processing and visualization in laboratory and non-laboratory environments. Examples of such use include, but are not limited to: examination and reconstruction of cancer cells invading host tissue, benign and malignant growths in relationship to host structures, tissue damaged by trauma or usage, and congenitally abnormal tissues and structures.

While the embodiments discussed herein are detailed using examples involving animal tissue, an example embodiment of the present invention may also be entirely suitable for similar purposes in reconstructing spatial details and relationships in tissues from plants, bryophytes, fungi, lichens, etc. Further, the present invention may be useful as a means for providing the data to enable detailed three-dimensional reconstruction of any specimen that is soft enough and of a consistency that it may be sectioned and imaged. An example of such a usage may be in the sectioning, imaging and subsequent three-dimensional reconstruction of a piece of fabric, perhaps showing details of damaged fibers and reliable data on the trajectory of a penetrating object, such as a bullet or blade. In short, an example embodiment of the present invention may be used with any soft tissue specimen removed from an animal, human, or plant.

In brief, an example embodiment of the present invention provides a programmable stage that, in addition to its normal use in microscopy, the programmable stage may be used as an integral component of (i.e., operates in a cooperative manner with) a specimen sectioning device that removes surface portions (e.g., sections) of the specimen. The thickness of the surface portions that are removed may be selected by changing the distance between the specimen and the sectioning device using the programmable focus controller. Changing the position of the sectioning plane of the sectioning device in relation to the specimen may include moving the sectioning device in the Z-axis relative to the specimen or moving the specimen in the Z-axis using the programmable stage relative to the sectioning device.

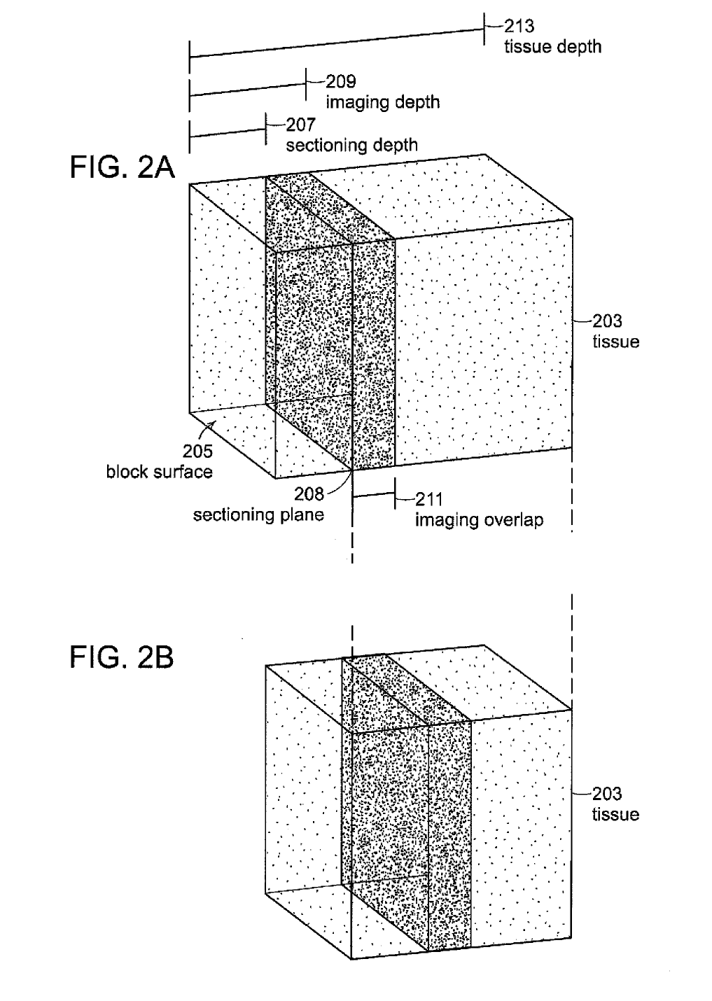

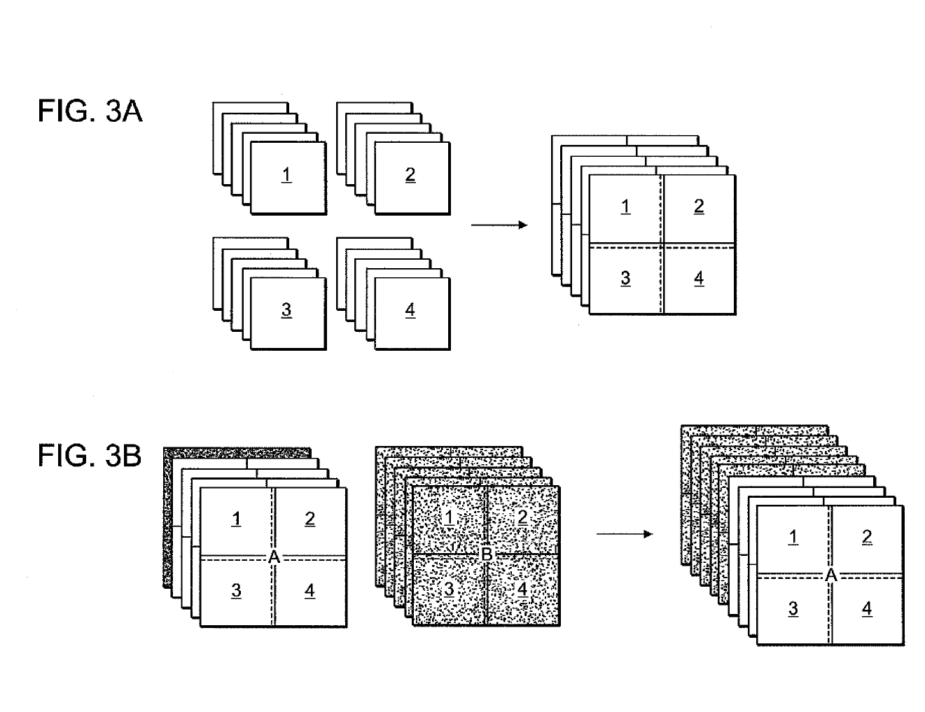

Use of a programmable microscope stage may allow for removal of surface portions in a controlled and automated manner and may also allow the user (e.g., person or machine) to reposition the specimen precisely under the microscope objective to image the regions or areas of the specimen previously imaged or to be newly imaged. For an example embodiment of the present invention to be automated, a specimen bath may be included to allow for the specimen to be submerged in a fluid. The specimen bath may also be used for collecting sections for further processing (e.g., staining) and analysis. The thickness of the portions of the specimen that are imaged may be greater than the thickness of the portions that are removed, allowing overlap between successive image stacks of the same regions (see FIGS. 2A and 2B). In addition, the different regions that are imaged may be overlapping, making it possible to align image stacks precisely in X, Y, and Z directions (see FIGS. 3A and 3B). The present invention and methods therefore provide a novel way in which to create three-dimensional images of large fluorescence structures, where the images have a high degree of spatial resolution.

The way in which the selected surface portions of the specimen are removed by the sectioning device may vary. In an exemplary embodiment, the sectioning device may be mounted in a fixed position, and the specimen may be moved on a programmable stage to the sectioning device. Alternatively, the specimen may be in a fixed position on the microscope stage, and the sectioning device may be directed on a programmable stage to the specimen. Some embodiments of the present invention do not require physical modifications of an existing microscope system; software control for automation of imaging and sectioning need only be implemented in a modified or new form. Some example embodiments may be employed with any confocal or multi-photon microscope system that has an upright stand and a programmable stage because the sectioning device is sufficiently small to work with most if not all of today's motorized stage microscope systems without modification.

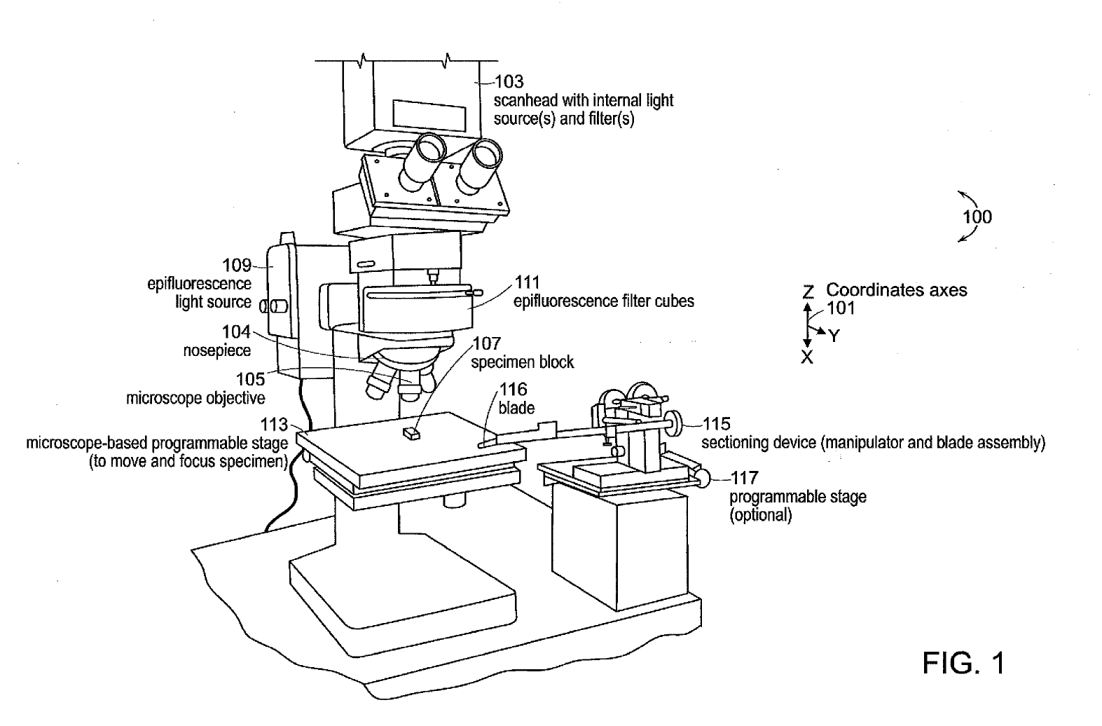

FIGS. 1 through 5 present an example microscope system, high-resolution imaging and sectioning processes, and images acquired using example embodiments of the present invention.

FIG. 1 is a drawing of a laser scanning microscope system 100 according to an example embodiment of the present invention suitably configured for generating high-resolution three-dimensional images of thick specimens. The laser scanning microscope system 100 includes a scanhead 103 with internal light source(s) and filter(s), nosepiece 104, microscope objective 105, specimen block 107, epifluorescence light source 109, epifluorescence filter cubes 111, microscope-based programmable stage 113, sectioning device (manipulator and blade assembly) 115, blade 116, and programmable stage 117. It should be understood that the aforementioned components and arrangement thereof are provided for illustration purposes only. More or fewer components may be used in other example embodiments, combinations of components may be used, and so forth, as known in the art. For example, typical microscope systems include multiple light sources, sensors, and selectable objectives for selectable resolutions. Further control processor(s) (not shown) executing software to control the components that are computer controllable may be general purpose or application specific processor(s) that can control the component(s) of this as described herein. Software loaded and executed by the processor(s) may be any software language capable of causing the processor(s) to perform operations consistent or in support of operations as illustrated by way of example herein.

In FIG. 1, the laser scanning microscope system 100 includes a component referred to as scanhead 103. The scanhead 103 may be used to obtain high resolution images of light emitted (emitted light) by a specimen (not shown) in response to being illuminated by incident light, where the incident light may have a wavelength lower or higher than the emitted light. In this example embodiment, the specimen is held in a fixed position on a microscope-based programmable stage 113 by a specimen block 107. The scanhead 103 can thus illuminate multiple microscopic portions of the specimen at known positions if registration between the programmable stage 113 and specimen remains fixed. For illustrative purposes, the specimen may be tissue containing fluorescently labeled cells, but may also be any suitably fluorescent specimen.

The nosepiece 104 may hold one or more microscope objectives 105, which allows for easy selection of each microscope objective 105. In FIG. 1, a microscope objective (objective) 105 is configured to be positioned a distance from the specimen block 107 at which at least a part of the specimen is within the in-focus plane of the objective 105. In an embodiment using an incident light beam that is significantly smaller in spot size at the in-focus plane of the objective 105, the regions may be referred to herein as “distinct” regions, meaning that the incident light beam is moved (e.g., in a raster pattern) from distinct region to distinct region within the focal plane; it should be understood that overlapping illuminated regions may also be referred to as distinct regions.

When the incident light illuminates the specimen at the in-focus plane of the objective 105, fluorescence emission occurs, and at least a portion of the emitted light is received and directed to the scanhead 103. The scanhead 103 may include a detector (not shown) that detects the emitted light and, in turn, produces a corresponding electrical signal, which may be captured and processed to render two-dimensional (2D) images (not shown) of multiple (for example, 100) layers of a section of the specimen corresponding to the number of movements of the in-focus plane of the objective 105 within the section of the specimen. The set of 2D images may themselves be rendered into a three-dimensional (3D) image. It should be understood that the rendering of the 2D or 3D images may be performed internally in the microscope system 100, if it is configured with an image processor for such a purpose, locally at a computer in communication via a wired, wireless, or fiber optic communications bus or link, or remotely via a network (not shown). Once the image (or just raw data) is captured, a thin section of the specimen may be removed from the block surface of the specimen by moving the microscope-based programmable stage 113 from an imaging location beneath the microscope objective 105 toward the manipulator and blade assembly 115 at a section removal location. The manipulator and blade assembly 115 may be connected to another motorized stage 117 for local movement, optionally in X, Y, or Z coordinate axes 101, or global movement to move the manipulator and blade assembly 115 to the specimen at the imaging area for sectioning. The sectioning device 115 may also be attached to the nosepiece 104, and sectioning may thus occur immediately adjacent to the imaging location.

Once a section of desired thickness has been removed from the specimen, the microscope-based programmable stage 113 may return the specimen to its original position under the objective 105, and the process of imaging and sectioning may be repeated until all areas, optionally in X, Y, or Z coordinate axes 101, of interest for the investigation have been imaged.

The objective 105 may be coupled to a programmable focus controller (not shown), which is configured to change the distance between the objective 105 and programmable stage 113 to move the in-focus plane of the objective 105 within the specimen.

Both programmable stages 113, 117 may include X-, Y- and Z-axis substages configured to move the specimen in at least one respective axis. In some embodiments, the Z-axis substage may position the in-focus plane within the specimen during imaging or a blade 116 of the sectioning device 115 within the specimen during sectioning, within a tolerance of 1 micron or other suitable tolerance. It should be understood that the tolerance may be based on mechanical, electrical, sampling, or other forms of error contributing to system tolerance.

FIGS. 2A and 2B illustrate a process by which high-resolution imaging and sectioning of a large tissue is done in accordance with an example embodiment of the present invention. Images are acquired from the cut surface of tissue (specimen) 203 that is immobilized in a material, such as agarose. The tissue 203 is mounted on an upright microscope with a programmable stage (not shown). The sample fluorescence specimen is imaged to a known depth (e.g., 100 μm±10 μm) using confocal or two-photon microscopy, for example. A thin section, referred to herein as the sectioning depth 207, which may be less than the imaging depth 209, is removed from the block surface (i.e., specimen) 205 at the sectioning plane 208 (represented as dark black lines) by moving the tissue 203 over a miniature tissue-sectioning device (not shown). The sectioning plane 208 sectioning plane 208 is the position of the top surface of the specimen 203 after removing a section. A stage supporting the specimen 203 or sectioning device height may control section thickness. Alternatively, the nosepiece (not shown) may hold the sectioning device and may control section thickness, allowing the stage supporting the specimen 203 to remain at a fixed position in the Z-axis. Programmable stage(s) make it possible to control speed and depth of sectioning (e.g., cutting) and then to return the tissue 203 under the microscope objective with precision registration for further imaging of a next section (i.e., after sectioning) with an imaging overlap 211 in the Z-axis with respect to the previously imaged section. The imaging overlap 211 between successive image stacks makes image alignment straightforward. Alignment is unaffected by blade chatter of the blade used for sectioning because of the imaging overlap 211, provided the imaging overlap 211 is sufficiently thick, which may be a function of characteristics of the tissue 203 and magnitude of blade chatter. The programmable stage also makes it possible to acquire image stacks that overlap in X and Y directions, thus extending the field of view for large specimens, such as being wider than the in-focus plane of the objective.

Continuing to refer to FIG. 2A, the tissue 203 contains fluorescently-labeled structures (not shown), such as green fluorescent protein (GFP) filled cells that are imaged using confocal or two-photon microscopy. Optical sections are imaged from the block surface 205 to a depth determined by the signal level of the emitted light and the light scattering properties of the tissue 203, typically 50 μm to 100 μm. A thin section is removed from the block surface 205 using the microscope-based sectioning device (see FIG. 1). The sectioning depth 207 may be adjusted during operation of an example embodiment of the invention to produce image overlap 211, which may be 20 μm to 30 μm for some tissues, and more or less for others, such as 1 μm to 10 μm, 10 μm to 100 μm, submicron, or other relevant amount for a given specimen.

FIG. 2B illustrates that the new block surface is imaged and sectioned in the same manner as described in reference to FIG. 2A, with the process repeating until the structures of interest within the tissue depth 213 are imaged.

Conventional confocal and two-photon microscope systems are unable to acquire high-resolution images more than approximately 100 microns to 300 microns deep into tissue, respectively. Image quality deteriorates quickly at greater depths due to light scattering by overlying tissue. With traditional histology methods, tissue can be cut into a series of thin sections (typically 3 microns to 5 microns) which are then stained and imaged. The alignment of images is difficult, however, because of section warping. Methods that directly image a block surface eliminate need for image alignment. In surface imaging microscopy (SIM), tissue is labeled by fluorescent dyes that are embedded in resin. The block surface is repeatedly imaged and sectioned using a fluorescence microscope equipped with a wide-field camera and an integrated microtome, for example, with a glass or diamond knife. An advantage of the SIM technique is that the axial resolution can be made the same as the resolution of the light microscope in X and Y coordinates axes. A disadvantage is that while some dyes remain fluorescent after tissue is dehydrated and embedded, GFP does not. Another existing method uses a two-photon laser to serially image and ablate a tissue specimen. A major disadvantage of the two-photon laser method is its speed because, in its current configuration, the maximum scan rate is limited to 5 mm per second. Tissue is ablated typically in 10 micron sections. Thus, the time that is required to remove 70 microns of tissue in a 1 mm by 1 mm square is at least 23 minutes. However, high-resolution imaging and sectioning of a large tissue by employing an example embodiment of the present invention is done in significantly less time, such as less than 5 minutes for a 1 cm by 1 cm block.

FIGS. 3A and 3B are schematic diagrams illustrating example three-dimensional reconstructions of a specimen imaged in accordance with an example embodiment of the present invention. In FIG. 3A, image stacks (stacks) 1, 2, 3, 4 may be acquired by overlapping in-focus planes or imaging depths, where imaging is from the cut surface of the specimen to a depth determined by the light scattering properties of the specimen, as described above. Structures that appear in the regions of overlap allow adjacent stacks to be aligned and connected to one another through post-processing based on features of the structures or other aspects that can be used in image processing for alignment purposes. The overlap between each stack 1, 2, 3, 4 is indicated in FIG. 3A as dashed lines in the resulting montage. In FIG. 3B, after removing a portion of the thickness from the specimen that was imaged, a second set of stacks may be acquired of the same fields of view, with a vertical adjustment to assert the in-focus plane at the newly exposed surface or within the specimen between the surface and imaging depth. Structures that appear deep in one montage are near the surface in the next, which permits alignment of successive montages. The montages may then be joined, eliminating planes from the first montage (bottom plane, A) that overlap with the second montage (top plane, B). The process may be repeated until all of the structures of interest have been sectioned and imaged.

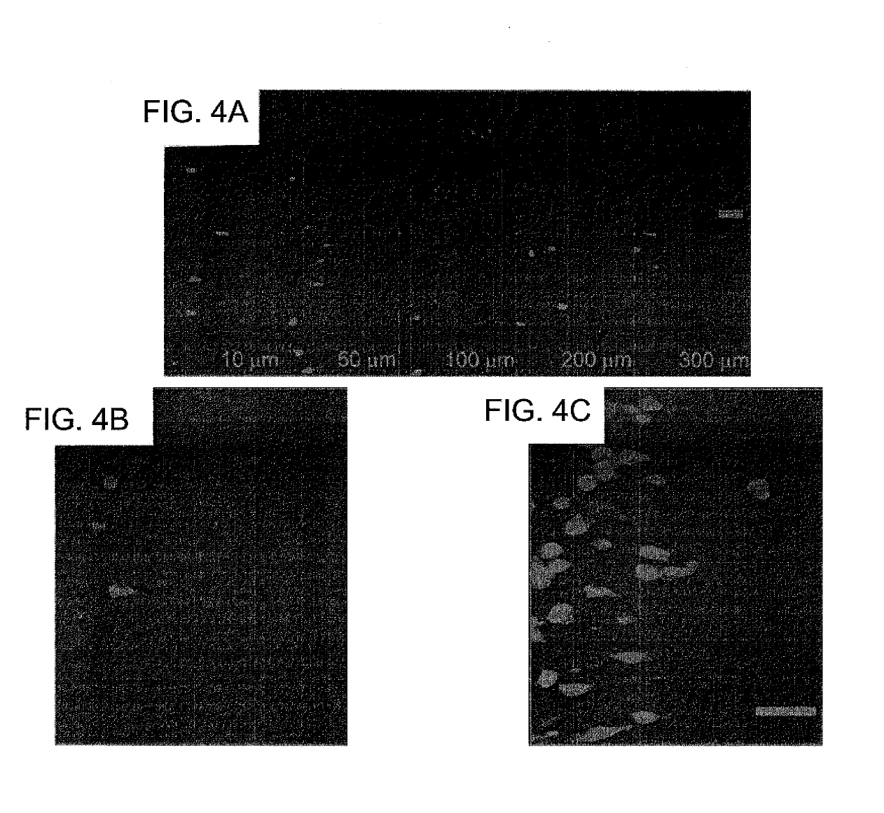

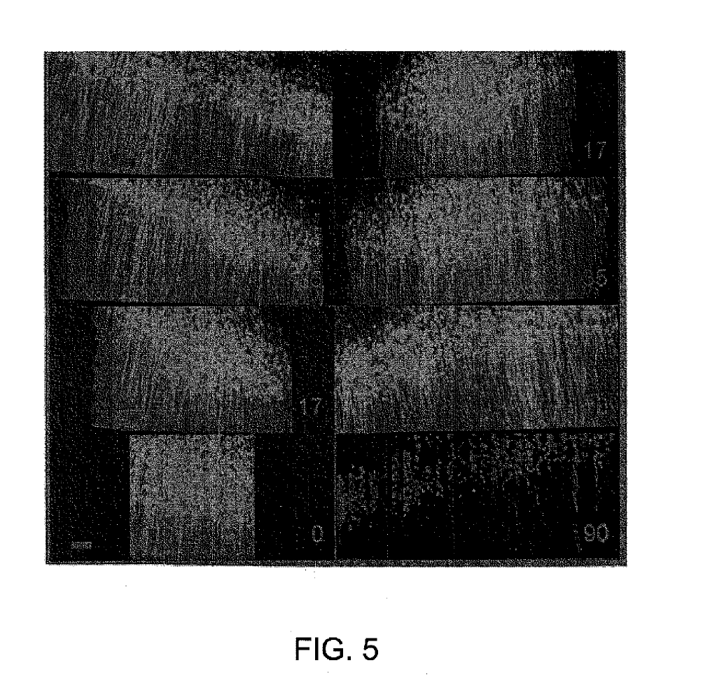

FIGS. 4A, 4B, 4C, and 5 depict imaging and reconstruction of thick specimen as done in accordance with example embodiments of the present invention. In one embodiment of the present invention, a specimen is fixed with paraformaldehyde. The fixation stiffens the specimen for cutting. The fixation may be applied to the specimen as generally well known in the art (such as by perfusing an animal with the fixative in aqueous solution, removing the specimen from the animal, post-fixing the specimen, rinsing with a saline solution to remove unbound fixative, and embedding the specimen in low-temperature agarose, keeping the specimen hydrated).

The specimen, e.g., brain tissue that is fixed and embedded in agarose, may be positioned on a suitably configured microscope stage. The specimen may be directed on the programmable microscope stage to the position of the sectioning device, which may include a manipulator and blade assembly that may be driven by a programmable stage, as illustrated in FIG. 1. The sectioning device may be controlled to remove selected surface portions of the embedded specimen. By choosing the selected surface portions according to the focus position (i.e., in-focus plane) of the microscope and directing the specimen to the sectioning device in a controlled and measured manner, surface portions of the specimen may be removed with the desired thickness.

In another embodiment of the present invention, the specimen is fixed with a stronger fixative, such as glutaraldehyde. This fixative may stiffen the cellular structure of the specimen, which may be bound together weakly by connective tissue. Furthermore, multiple fixatives applied together or in sequence may achieve the desired stiffness while having certain optical advantages, for example, reduced autofluorescence. For example, a muscle specimen may be fixed with a mixture of paraformaldehyde and glutaraldehyde. The muscle specimen then has adequate stiffness and optical characteristics to allow both sectioning and imaging.

The ability to remove portions of the specimen in sections with constant thickness depends on the type of tissue and the thickness to be cut. Fixation adequate for intended cutting therefore varies. For example, stronger fixation may be required for muscle versus brain. The variability in section thickness may also depend on cutting speed; however, variability in section thickness may be difficult to predict. In any case, the quality of sectioning may be improved by drawing the specimen over the sectioning device slowly, for example, at roughly 3 min per cm to 4 min per cm.

The fixation may be applied to the specimen as generally well known in the art, such as by immersing the specimen in an aqueous solution of the fixative, removing the specimen from the solution, post-fixing the specimen, then rinsing and embedding the specimen in agarose. Solutions of fixatives suitable for use according to an example embodiment of the present disclosure are known, and an example is described in the Exemplifications Section herein below.

FIGS. 4A through 4C illustrate a comparison of imaging of thick specimens using confocal microscopy in contrast to imaging using extended-depth confocal microscopy in accordance with an example embodiment of the present invention. In FIG. 4A, the same tissue volume was imaged first with confocal microscopy (top row) and then with an example embodiment of the present invention (bottom row). The imaging depth for FIG. 4A is shown beneath the two rows. Light scattering reduces image brightness and contrast such that the maximum imaging depth of confocal microscopy is less than 100 μm. An example embodiment of the present invention overcomes this imaging depth limitation by allowing imaging to be performed at a higher level of resolution through the full tissue volume. The difference in total signal collection over 300 μm is apparent from maximum intensity projections of FIG. 4B produced using an existing confocal microscopy technique and image stacks of FIG. 4C produced using an embodiment of the present invention. The image scale bars for FIGS. 4B and 4C are 100 μm.

FIG. 5 depicts a three-dimensional reconstruction of the distribution of principal (projection) neurons in the frontal lobe of a transgenic mouse expressing yellow fluorescent protein (YFP) under the CD90 cell surface protein (Thy1) promoter (adult, YFP-H line) as done using an example embodiment of the present invention. The neurons are elongated perpendicular to the cortical surface. The cells have long apical dendrites that extend from the cell bodies to the pial surface and short basal dendrites that branch locally. The brain was fixed with 4% paraformaldehyde, embedded in 8% agarose and cut transversely through the frontal lobe. The forebrain was mounted on a glass slide with the caudal portion (i.e., cut surface) facing up and the rostral-most portion facing down. A region of the cortex was imaged by confocal microscopy from the cut surface to a depth of 80 μm. The distance between the in-focus planes was adjusted to make cubic voxels. A 60 μm section was then removed from the block face using the programmable microscope stage to draw the specimen under the cutting tool in a precise and controlled manner. The specimen was moved back under the objective to continue imaging. This process was repeated 25 times. The individual stacks were aligned and merged resulting in a composite stack with 512×512×1163 pixels (635×635×1442 cubic μm). The numbers in the lower left corner of each subsection indicates the viewing angles. Top-down and side-on views of the composite stack are viewing angles 0 and 90, respectively. The image scale bar for each subsection is 100 μm.

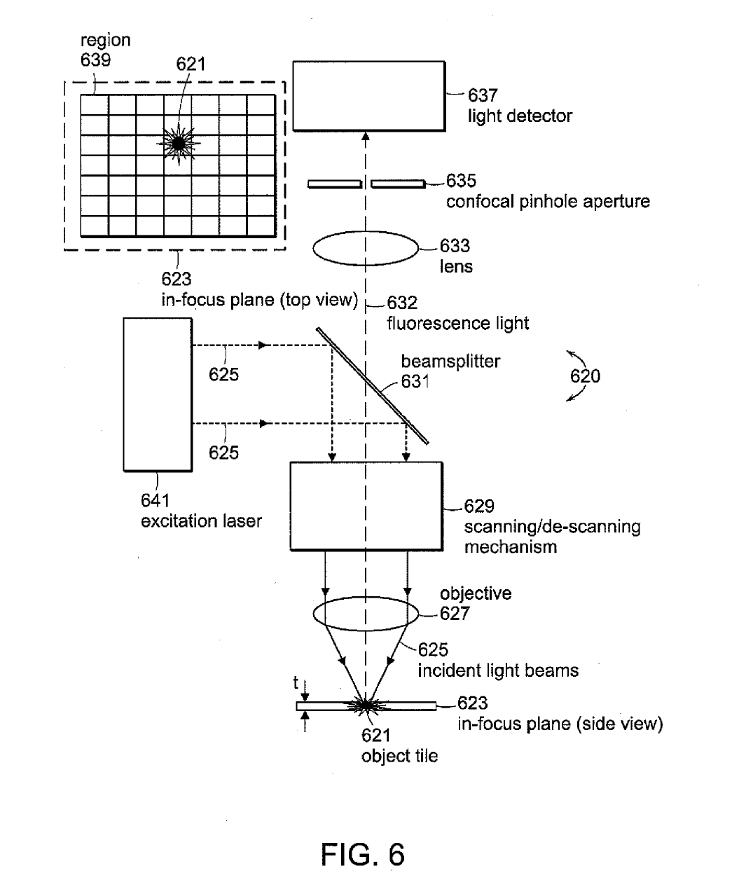

Now that an example system, description of imaging and sectioning of a specimen, and results of imaging have been presented, details of the system, including a network embodiment, and methods for use thereof are presented in reference to FIGS. 6-11D.

FIG. 6 is a schematic diagram providing detail of another example of a laser scanning microscope system 620 suitably configured for generating high resolution images of a specimen in accordance with the present invention. Referring to FIG. 6, the example laser scanning microscope system (microscope) 620 includes a scanning/de-scanning mechanism 629, beam splitter 631, objective 627, lens 633, confocal pinhole aperture 635, light detector 637, and excitation laser 641. The excitation laser 641 generates laser light at wavelengths within a range of 440 nm and 980 nm, for example, and directs the laser light outward as “incident light” 625. The dimensions of the incident light 625 are controlled by any means known in the art so that only a precisely defined area of the specimen is exposed to the incident light 625. For example, the incident light 625 may be focused by the objective 627 and optionally other optical elements (not shown) to narrow the incident light 625 and achieve very tightly, spatially controlled illumination of the specimen at the in-focus plane 623 of the objective 627, as described above in reference to FIG. 1.

Continuing to refer to FIG. 6, the incident light beams 625 is directed along the incident light path (represented as dashed lines with arrows to show path direction) to the specimen (at an in-focus plane 623) via the beam splitter 631, scanning/de-scanning mechanism 629, and objective 627. In at least one example embodiment, the scanning/de-scanning mechanism 629 employs a raster scanner (not shown) and suitable lenses (not shown) for serially directing a plurality of collimated incident light beams 625 off the beam splitter 631 and through the objective 627 for serially illuminating different portions of the specimen. The objective 627 focuses the incident light beams 625 onto the specimen at the in-focus plane 623. The incident light beams 625 emitted from the scanning/de-scanning mechanism 629 may be directed to the objective 627 at different angles so that the incident light beams 625 are focused at different regions of the in-focus plane 623 of the objective 627. In other words, the scanning/de-scanning mechanism 629 may serially direct incident light beams 625 to a plurality of regions 639 (e.g., object tile 621) of the in-focus plane 623.

The scanning/de-scanning mechanism 629 may divide the in-focus plane 623 of the objective 627 into a plurality of regions 639 (e.g., 512×512 grid regions) and serially direct the incident light beam 625 to each region 639. For illustrative purposes, a collection of regions 639 are shown in a top view of the in-focus plane 623 at an enlarged scale. An object tile 621 of the specimen, which may be positioned in a region 639 of the in-focus plane 623, may absorb incident light beams 625 and emit fluorescence light 632. Although the in-focus plane 623 is identified as a plane, it should be understood that the in-focus plane 623 actually has a thickness proportional to the depth of field of the objective 627. Likewise, each region 623 has a thickness t (i.e., a distance from top to bottom), which may be proportional to the depth of field of the objective 627 and extends into the specimen up to an imaging depth, as described in reference to FIG. 2A. Although the numerical aperture (NA) of the objective 627 is preferably 0.9 or higher, it should be understood that the NA may have some other value without departing from the scope of this example embodiment of the present invention.

Continuing to refer to FIG. 6, when the microscope 620 is in operation, the excitation laser 641 outputs a laser beam as incident light 625 to illuminate the specimen at the in-focus plane 623. A sensor unit, such as the light detector 637, may be configured to sense light emitted by the specimen at select wavelengths of a spectrum of emitted light. For example, the emitted light 632 may be directed through the beam splitter 631 to the confocal pinhole aperture 635. The emitted light 632 passing through the pinhole aperture 635 is then detected by the light detector 637. The light detector 637 may employ a photo-multiplier tube (PMT) (not shown) or other detector configured to generate an electrical signal, such as current or voltage, in response to receipt of the emitted light 632, or filtered version thereof. Detecting light emitted from a particular portion at the in-focus plane of the specimen may include sensing wavelengths of the fluorescence light 632. As should now be understood, the operation may employ a programmable stage to support the specimen or to change a position of the specimen to position other portions of the specimen, which were previously outside the in-focus plane 623, to be within the in-focus plane 623.

There are several embodiments of a general method of creating three-dimensional images of thick specimens in accordance with the present invention. The specimen may be positioned in the optical field of view and may be visualized using fluorescence optics. As described supra, the scanning/de-scanning mechanism 629 may divide the in-focus plane 623 of the objective 627 into a plurality of grid regions (regions) 639. The regions 639 may be any sort of regular pattern, as desired, that is suitable for imaging the specimen. Moreover, any equivalent means of dividing an in-focus plane 623 of an objective 627 of a laser scanning microscope system 620 into a plurality of grid, discrete or continuous regions 639 conducive to imaging the specimen may also be employed. In one embodiment, the grid regions 639 of the in-focus plane 623 of the objective 627 are of a thickness proportional to the depth of field of the objective 627.

Continuing to refer to FIG. 6, the microscope 620 may include: a photo-multiplier tube (PMT) or a solid-state detector, such as a photo-diode or a charge-coupled device (CCD) array, (optionally deployed inside light detector 637) to divide an in-focus plane 623 of an objective 627 of the microscope 620 (e.g., a confocal or multi-photon microscope) into a plurality of regions 639; an optical light generator (represented as the excitation laser 641) to generate light to illuminate the specimen; or optics to direct incident light to illuminate the portions of the specimen that are within the regions 639. The light detector 637 may be configured further to sense light emitted from the portions associated with at least a subset of the grid regions 639. An imaging controller (not shown) may be contained in or coupled to a scanning/de-scanning mechanism 629 and configured to cause the light detector 637 to image the specimen in a selectable manner in at least a subset of the grid regions 639.

In summary, FIG. 6 illustrates examples of operation with example embodiments that may be employed to image a specimen in accordance the present invention. The specimen may be imaged by dividing the in-focus plane 623 of an objective 627 into a plurality of grid regions 639. Another operation of imaging a specimen may be to position at least a portion of the specimen a distance from the objective 627 within at least a subset of the grid regions 639 at the in-focus plane 623. One may also direct incident light 625 to illuminate the portions of the specimen that are within the grid regions 639. Another option to image a specimen may be to use the light detector 637 to detect light emitted from the portions associated with at least a subset of the grid regions 639. Note that any of the aforementioned operations of methods to image a specimen may be employed either individually or in any combination thereof. Imaging of the specimen may also be done by selectively imaging the specimen in at least a subset of the grid regions 639.

Manipulations of an example embodiment of the present invention may be used to change the in-focus plane as desired, and new grid regions may be established in the new plane of focus so that other select regions of the specimen may be excited by the incident light. Serial manipulations may be used to change the in-focus plane, thereby allowing sequential imaging as desired using sequential imaging of portions of the specimen in each succeeding in-focus plane.

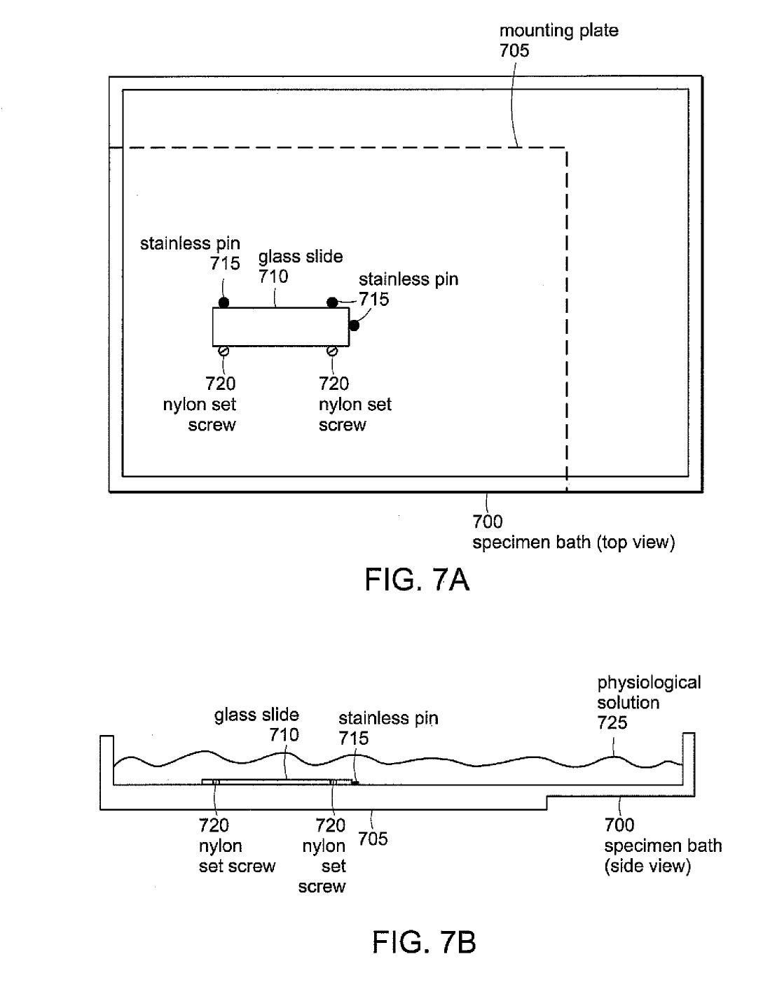

FIGS. 7A through 7B are diagrams of a microscope-stage specimen bath that may be used in accordance with the present invention. In FIG. 7A, the microscope-stage specimen bath (specimen bath) 700 that permits immersion of the specimen block (not shown), microscope objective (not shown), and sectioning device (not shown) for automated sectioning and imaging in an example embodiment of the present invention. The specimen bath 700 is made of a lightweight, corrosion-resistant material, such as aluminum or Delrin. A mounting plate 705 is on the underside of the bath (indicated as dotted lines in FIG. 7A and visible in FIG. 7B). The mounting plate 705 allows the specimen bath 700 to be used as a microscope stage insert. In an example embodiment, a specimen block is attached to a polylysine-coated glass slide 710 using super glue. The glass slide 710 is mounted between stainless pins 715 and nylon set screws 720, and the specimen bath 700 is filled with a physiological solution 725 (0.01 M Phosphate Buffered Saline).

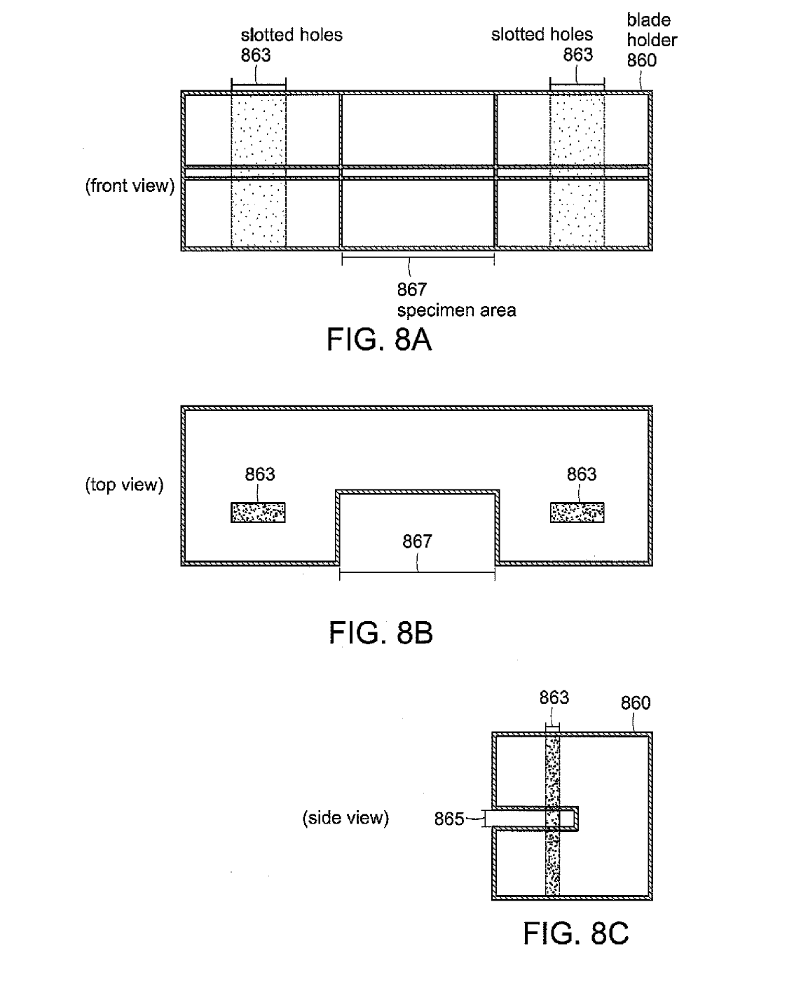

FIGS. 8A through 8C are schematic diagrams of front, top, and side views, respectively, of a blade holder 860 that may be used in a blade assembly in accordance with an example embodiment of the present invention. The views illustrate that the blade holder 860 may include slotted holes 863 to hold pins (not shown) that ensure alignment of a blade (not shown), a blade slit 865 for the blade, and specimen area 867 to allow the specimen to move past the blade while being cut.

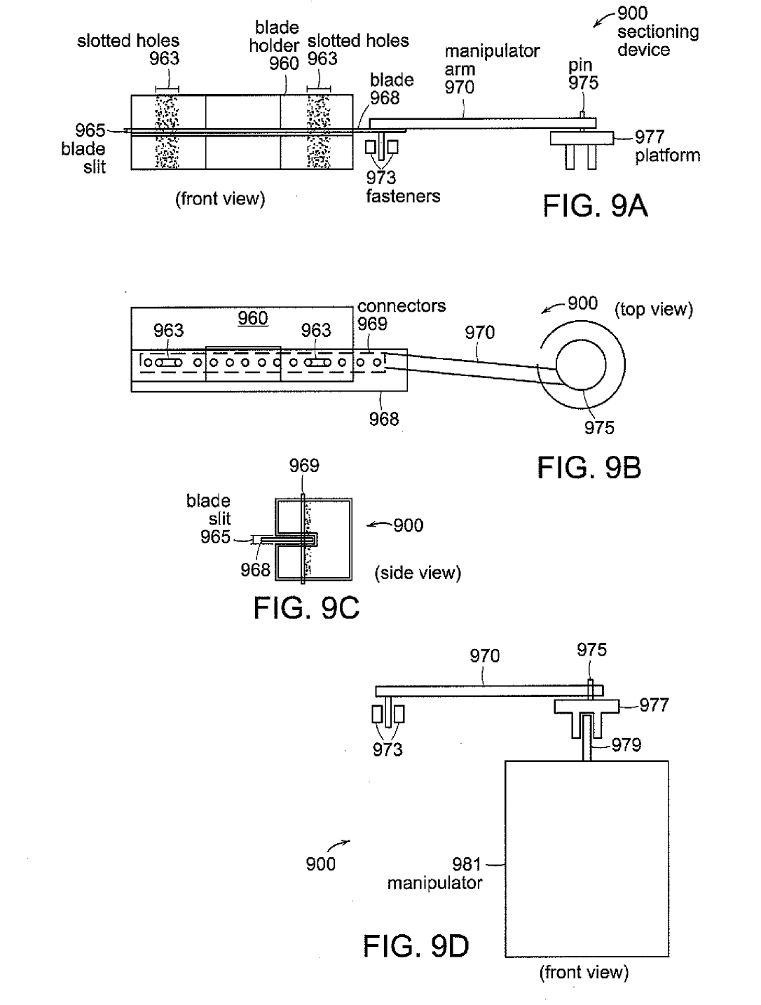

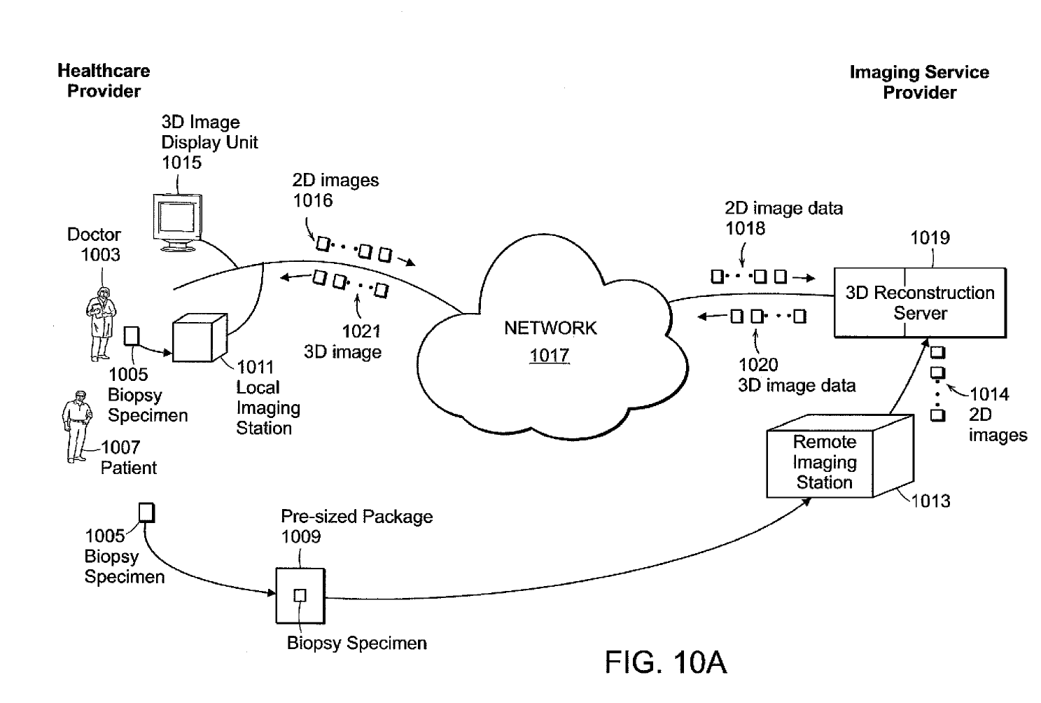

FIGS. 9A through 9D are schematic diagrams of a sectioning device 900 comprising a blade holder 960 coupled to a manipulator 981 that may be used in accordance with the present invention. A blade 968 has been placed in the blade slit 965. The blade 968 may have connectors 969 that fit into the slotted holes 963 of the blade holder 960. The blade 968 may be coupled to a manipulator arm (arm) 970 that has fasteners 973 to allow for insertion and extraction of the blade 968. The arm 970 may be connected by a pin 975, as shown, to a platform (or disk) 977 at a location offset from the center of the platform 977, where the platform 977, in turn, is connected via a pin 979 to the manipulator 981.

The blade 968 in the blade holder 960 may be used to remove a portion of the thickness of the volume of a specimen, which includes cutting a section in an oscillatory manner (e.g., substantially linear dimension with regard to blade holder 960). The blade 968 may be configured to cut sequential sections of the specimen with thicknesses between about 1 micron and 50 microns, 1 micron and 10 microns, and 2 microns and 4 microns. The blade 968 may be moved relative to the specimen or the blade holder 960 within a tolerance of less than 1 micron in the Z-axis. The fasteners 973 and pins 975, 979 are used for example purposes only; any appropriate means of fastening, securing, or interconnecting the components of the blade holder 960 or manipulator 981 known by one skilled in the art may be employed. As an alternative embodiment, the blade 968 may include a non-vibrating diamond or glass blade to cut sequential sections of the specimen embedded in wax or resin with thicknesses between 50 nm and 200 nm, or 0.5 microns and 5 microns. The blade 968 may be moved relative to the specimen or the blade holder 960 within a tolerance of less than 50 nm.

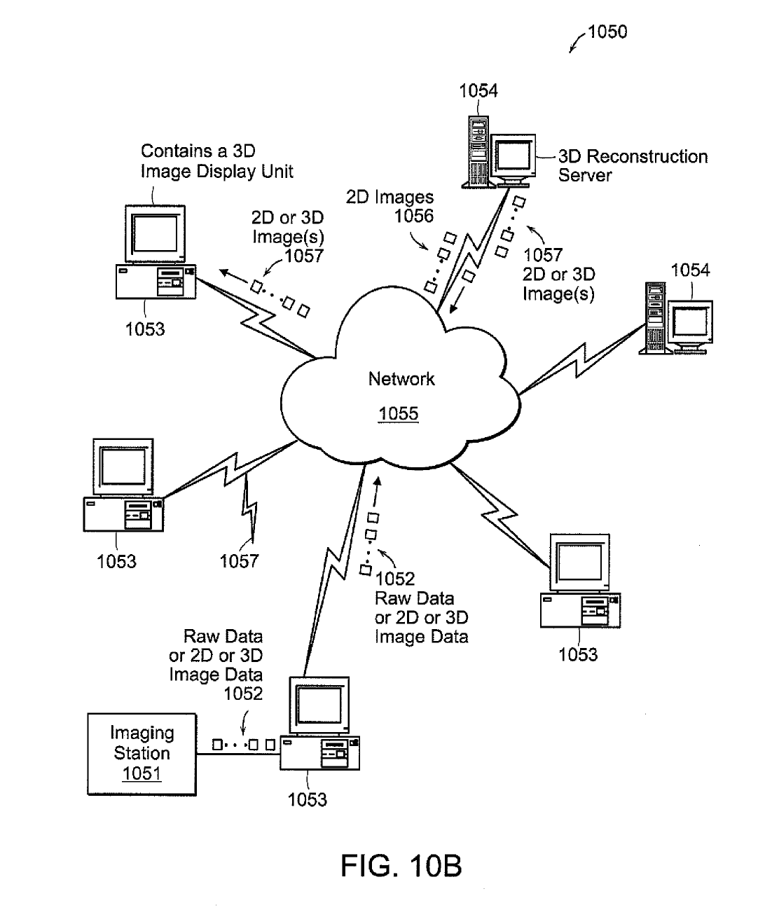

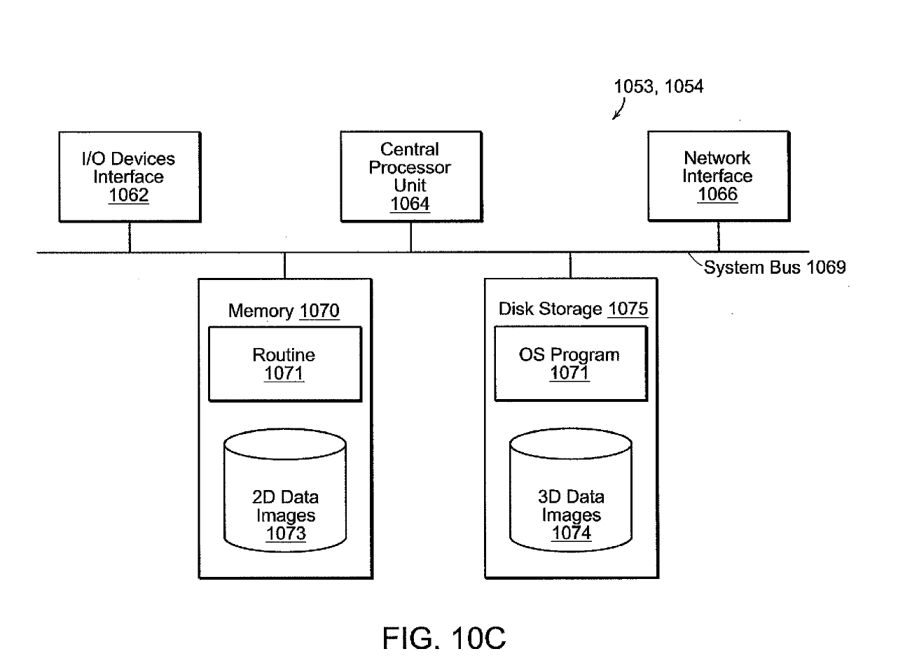

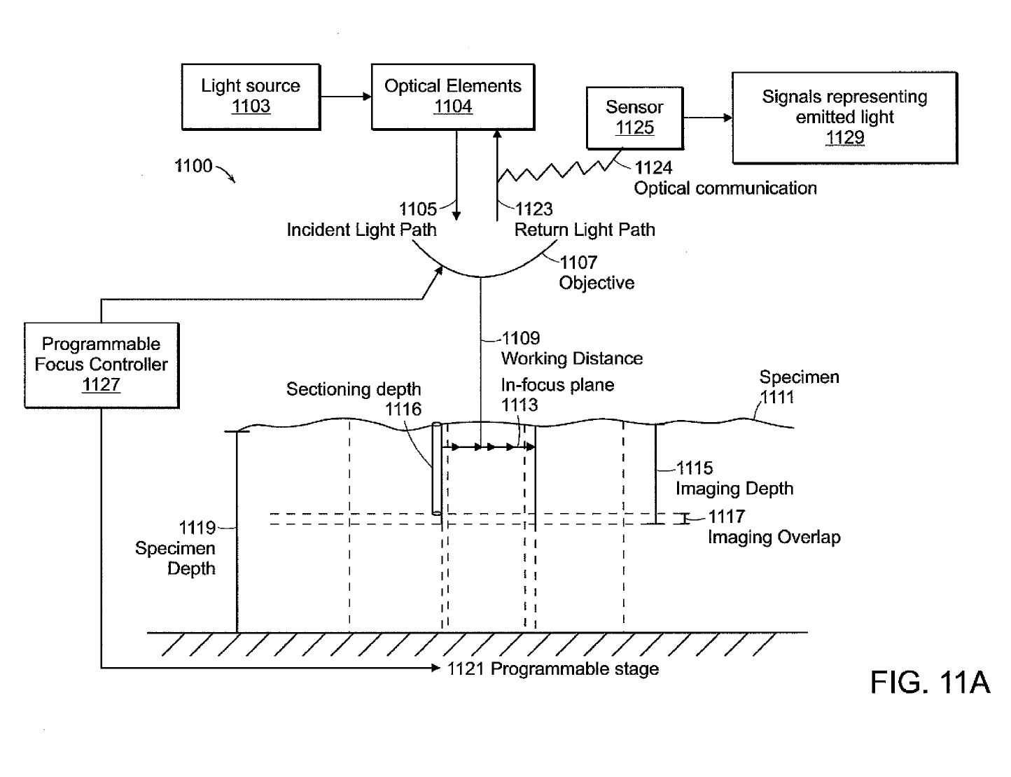

FIG. 10A is a diagram illustrating the use of an example embodiment of the present invention to provide data for healthcare providers. In FIG. 10A, a doctor 1003 removes a biopsy specimen (specimen) 1005 from a patient 1007. The biopsy specimen (specimen) 1005 is then sent (either directly by the doctor 1003 or using a pre-sized package 1009) to an imaging station (either local 1011 or remote 1013). The local imaging station 1011 is connected to a 3D image display unit 1015 or to a network (local area or wide area network) 1017. The local imaging station 1011 collects 2D images of the specimen 1005 and directs the collected 2D images 1016 to the network 1017. It should be understood that 2D images and sets of 2D images may be used interchangeably. The network 1017 transmits said 2D image data 1018 to a 3D reconstruction server 1019. Additionally, the pre-sized package 1009 may be delivered to the remote imaging station 1013. The remote imaging station 1013 generates 2D images 1014 of the biopsy specimen 1005 that are transmitted to the 3D reconstruction server 1019.

Continuing to refer to FIG. 10A, the 3D reconstruction server 1019 uses the transmitted 2D image data 1018 to reconstruct a 3D image 1021 of the biopsy specimen 1005 by erasing overlapping images and stitching together a 3D image 1021 of the biopsy specimen 1005 based upon the non-overlapping images. Next, the 3D reconstruction server 1019 transmits the 3D reconstructed or adjusted image 1021 as 3D image data 1020 to the network 1017. The network 1017 transmits the 3D image 1021 to the 3D image display unit 1015. The doctor 1003 is then able to view the 3D image 1021 of the biopsy specimen 1005. The 3D image 1020 may be displayed to the patient 1007 or a person associated with healthcare for the patient, such as a doctor 1003, nurse, parent, and so forth. Note that after collecting multiple 2D images 1016 representing respective multiple layers of the biopsy specimen, the collected 2D images are transmitted via a network to reconstruct the 3D image at a location in the network apart from the imaging. The aforementioned steps may be done using either the local imaging station 1011 or the remote imaging station 1013.

FIG. 10B is a network diagram illustrating a computer network or similar digital processing environment 1050 in which the present invention may be implemented.

Client computer(s)/devices 1053 and server computer(s) 1054 provide processing, storage, and input/output devices executing application programs and the like. Client computer(s)/devices 1053 can also be linked through communications network 1055 to other computing devices, including other client devices/processes 1053 and server computer(s) 1054. For example, a client computer 1053 may be in communication with an imaging station 1051, which transmits raw data or 2D or 3D image data 1052 to the client computer 1053. The client computer 1053 then directs the raw data or 2D or 3D image data 1052 to the network 1055. Additionally, a 3D reconstruction server 1054 may receive 2D images 1056 from the network 1055, which will be used to reconstruct a 2D or 3D image(s) 1057 that will be sent via the network 1055 to a 3D image display unit on a client computer 1053. Communications network 1055 can be part of a remote access network, a global network (e.g., the Internet), a worldwide collection of computers, Local area or Wide area networks, and gateways that currently use respective protocols (TCP/IP, Bluetooth, etc.) to communicate with one another. Other electronic device/computer network architectures are suitable.

With respect to the imaging system 100 of FIG. 1, for example, the imaging system 100 may transmit data from its scanhead 103 via a local bus (not shown) to one of the computers 1053, 1054 of the network environment 1050 for local processing (e.g., 3D image generation) or transmission via the network 1055 for remote processing. Similarly, local or remote display of 2D or 3D data is also possible, as understood in the art.

FIG. 10C is a diagram of the internal structure of a computer (e.g., client processor/device 1053 or server computers 1054) in the computer system of FIG. 10B. Each computer 1053, 1054 contains system bus 1069, where a system bus (bus) is a set of hardware lines used for data transfer among the components of a computer or processing system. Bus 1069 is essentially a shared conduit that connects different elements of a computer system (e.g., processor, disk storage, memory, input/output ports, network ports, etc.) that enables the transfer of information between the elements. Attached to system bus 1069 is I/O device interface 1062 for connecting various input and output devices (e.g., keyboard, mouse, displays, printers, speakers, etc.) to the computer 1053, 1054. Network interface 1066 allows the computer to connect to various other devices attached to a network (e.g., network 1055 of FIG. 10B). Memory 1070 provides volatile storage for computer software instructions 1071 and 2D data images 1073 used to implement an embodiment of the present invention. Disk storage 1075 and memory provides non-volatile storage for computer software instructions 1071 and 3D data images 1074 used to implement an embodiment of the present invention. Central processor unit 1064 is also attached to system bus 1069 and provides for the execution of computer instructions.

In one embodiment, the processor routines 1071 and 2D data images 1073 or 3D data images 1074 are a computer program product (generally referenced 1071), including a computer readable medium (e.g., a removable storage medium such as one or more DVD-ROM's, CD-ROM's, diskettes, tapes, etc.) that provides at least a portion of the software instructions for the invention system. Computer program product 1071 can be installed by any suitable software installation procedure, as is well known in the art. In another embodiment, at least a portion of the software instructions may also be downloaded over a cable, communication and/or wireless connection. In other embodiments, the invention programs are a computer program propagated signal product 1057 embodied on a propagated signal on a propagation medium (e.g., a radio wave, an infrared wave, a laser wave, a sound wave, or an electrical wave propagated over a global network such as the Internet, or other network(s)). Such carrier medium or signals provide at least a portion of the software instructions for the present invention routines/program 1071.

In alternative embodiments, the propagated signal is an analog carrier wave or digital signal carried on the propagated medium. For example, the propagated signal may be a digitized signal propagated over a global network (e.g., the Internet), a telecommunications network, or other network. In one embodiment, the propagated signal is a signal that is transmitted over the propagation medium over a period of time, such as the instructions for a software application sent in packets over a network over a period of milliseconds, seconds, minutes, or longer. In another embodiment, the computer readable medium of computer program product 1071 is a propagation medium that the computer system 1053 may receive and read, such as by receiving the propagation medium and identifying a propagated signal embodied in the propagation medium, as described above for computer program propagated signal product.

Generally speaking, the term “carrier medium” or transient carrier encompasses the foregoing transient signals, propagated signals, propagated medium, storage medium and the like.

For example, the present invention may be implemented in a variety of computer architectures. The computer network of FIGS. 10B and 10C are for purposes of illustration and not limitation of the present invention.

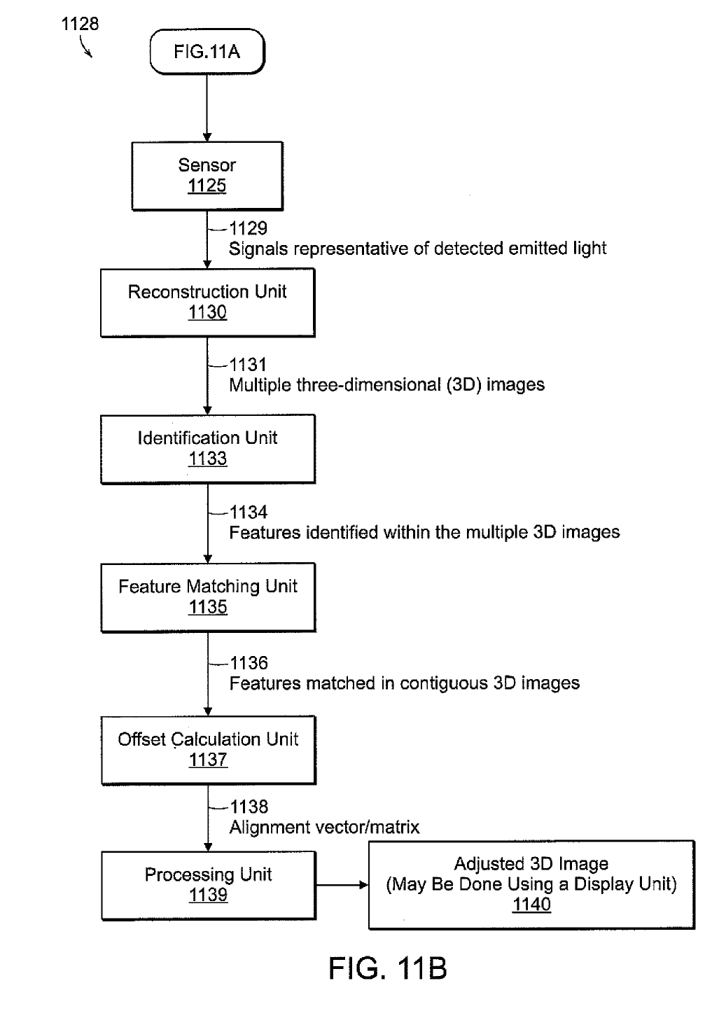

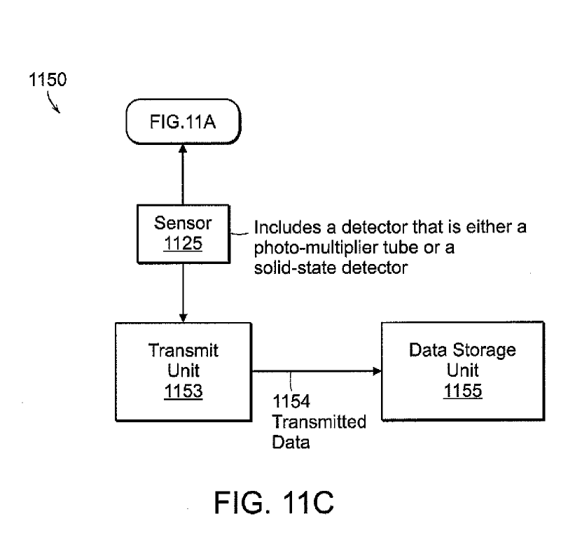

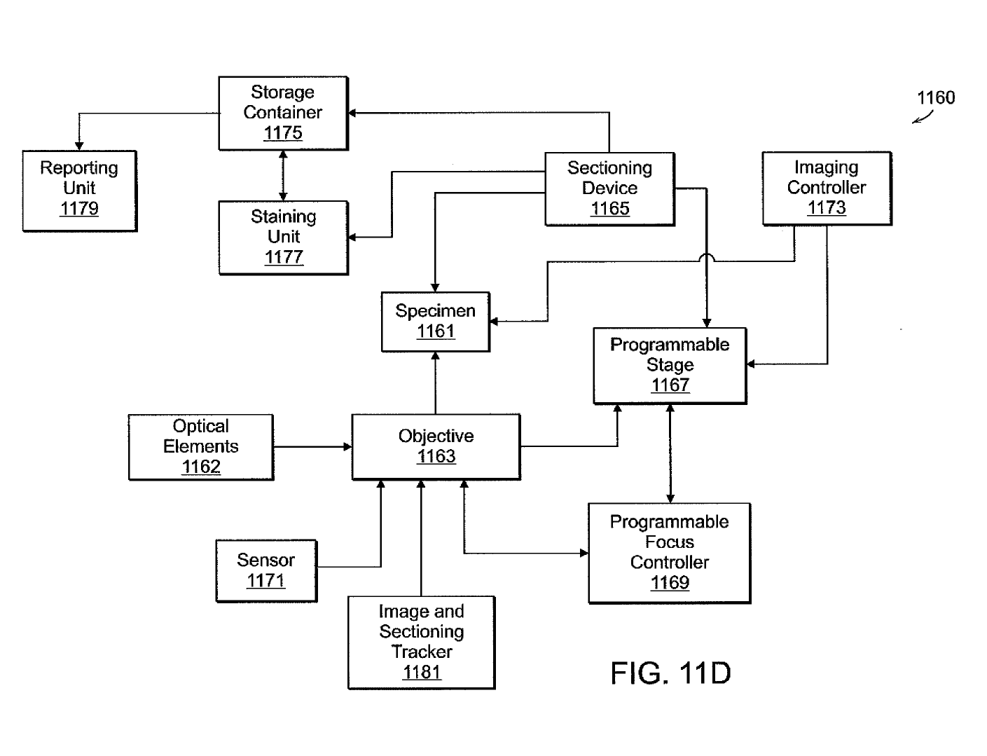

FIGS. 11A through 11D illustrate an example embodiment of the present invention configured for generating a high-resolution three-dimensional image of a thick specimen.

FIG. 11A illustrates an example system 1100 for generating a high-resolution three-dimensional image of a thick specimen in accordance with the present invention. The objective 1107 is spaced a distance from the specimen 1111 at which at least part of the specimen 1111 is within the in-focus plane 1113 of the objective 1107. The objective 1107 has a working distance 1109, which is the distance from the front lens of the objective 1107 to the surface of the specimen 1111 for which the objective 1107 most strongly converges (represented as in-focus plane 1113). The optical elements 1104 direct incident light (not shown) from a light source 1103 along an incident light path 1105 to multiple regions of the in-focus plane 1113 of the objective 1107.

Continuing to refer to FIG. 11A, the in-focus plane 1113 is placed at an imaging depth 1115 within the specimen depth 1119. The imaging depth 1115 is a function of the characteristics of the optical elements 1104 and the specimen 1111. The incident light causes the specimen 1111, at the in-focus plane 1113, to produce emitted light (not shown) responsive to the incident light. Directing light to multiple regions of the in-focus plane 1113 includes directing separate beams of incident light to the regions and the emitted light includes separate beams of emitted light corresponding to the specimen within the in-focus plane 1113. Directing light may also include serially directing incident light to each region to illuminate separately the specimen within the in-focus plane, which includes scanning the specimen to illuminate sequentially the specimen within the in-focus plane. The optical elements 1104 also direct the emitted light along a return light path 1123. The sensor 1125 is in optical communication 1124 with the return light path 1123 to detect the emitted light from the multiple regions of the in-focus plane 1113 of the objective 1107 and to generate signals representative of detected emitted light 1129. The sensor 1125 may detect light emitted by the specimen 1111 at select wavelengths of a spectrum of the emitted light.

In FIG. 11A, the specimen 1111 is placed on a programmable stage 1121 that allows for imaging and sectioning the specimen (using a sectioning device, see FIGS. 1, 8A-8C, and 9A-9D) as described previously. The programmable stage 1121 is in operative arrangement with the objective 1107 and sectioning device (not shown) and configured to support and move the specimen 1111. The programmable stage 1121 moves the objective 1107 to image at least one area of the specimen 1111 and also moves relative to the sectioning device to section the specimen 1111 in a cooperative manner with the sectioning device. A programmable focus controller 1127 changes the distance between the objective 1107 and programmable stage 1121 to move the in-focus plane 1113 of the objective 1107 within the specimen 1111. The sectioning depth 1116 may be less than the imaging depth 1115 to produce partial overlap in contiguous 3D images of the same field of view of the objective 1107 before and after sectioning. The programmable focus controller 1127 moves the objective 1107 relative to the programmable stage 1121, or the programmable stage 1121 relative to the objective 1107, to change the distance between the objective 1107 and the specimen 1111 to bring more portions of the specimen 1111 within the in-focus plane 1113 of the objective 1107.

Another embodiment of the present invention employs a nosepiece (not shown, see nosepiece 104 of FIG. 1) that is equipped with a sectioning device and the programmable focus controller 1127 moves the nosepiece relative to the programmable stage 1121 to define how much depth of the specimen 1111 is to be sectioned.

FIG. 11B illustrates an example embodiment that generates an adjusted three-dimensional image in accordance with the present invention. The sensor 1125 is in communication with a reconstruction unit 1130 that reconstructs multiple three-dimensional images based upon multiple sets of two-dimensional images based on signals representative of the emitted light. The reconstruction unit 1130 transmits multiple three-dimensional images 1131 to an identification unit 1133, which identifies features in the multiple three-dimensional images 1134. The features identified within the multiple three-dimensional images 1134 are transmitted to a feature matching unit 1135. The feature matching unit 1135 determines matching features in contiguous three-dimensional images 1136 that are sent to an offset calculation unit 1137. The offset calculation unit 1137 calculates offsets of the matching features to generate an alignment vector or matrix 1138. A processing unit 1139 processes the contiguous three-dimensional images as a function of the alignment vectors or matrix 1138 to generate adjusted data representing an adjusted three-dimensional image 1140. The adjusted three-dimensional image 1140 may be displayed using a display unit (not shown).

FIG. 11C illustrates an additional embodiment of the present invention that may be employed to generate a high-resolution three-dimensional image of a thick specimen. The sensor 1125 may include a detector that is either a photo-multiplier tube or a solid-state detector, such as photo-diode or a charge-coupled device (CCD) array. The sensor may be in communication with a transmit unit 1153 configured to transmit data 1154 via a network to a reconstruction server (not shown) to reconstruct a three-dimensional image of the specimen at a location in the network apart from the sensor. The data represents two-dimensional images, which signify layers of the specimen within the imaging depth of the objective. The transmitted data 1154 from the transmit unit 1153 is received by the data storage unit 1155. The data storage unit 1155 stores data representing the two-dimensional or three-dimensional images (e.g., transmitted data 1154).

FIG. 11D illustrates additional details of an example system 1160 of the present invention configured to generate a high-resolution three-dimensional image of a thick specimen. The system 1160 comprises a specimen 1161, optical elements 1162, an objective 1163, a sectioning device 1165, a programmable stage 167, a programmable focus controller 1169, a sensor 1171, an imaging controller 1173, a storage container 1175, a staining unit 1177, and reporting unit 1179. The specimen 1161, optical elements 1162, objective 1163, programmable stage 1167, and programmable focus controller 1169 function as previously described in FIG. 11A.

Continuing to refer to FIG. 11D, the sectioning device 1165 is able to section the specimen 1161 with a sectioning depth of less than the imaging depth. The sectioning device 1165 also oscillates a blade relative to a blade holder in a substantially uni-dimensional manner. An image and sectioning tracker 1181 determines the distance and tilt between the in-focus plane of the objective 1163 (see in-focus plane 1113 of the objective 1107 in FIG. 11A) and the sectioning plane of the sectioning device 1161 (see sectioning depth 1116 of the specimen 1111 of FIG. 11A) to support accurate imaging and sectioning. “Tilt” is a deviation of the plane of the surface of the specimen 1161 relative to the in-focus plane of the objective 1163 (i.e., normal to the optical axis of the objective 1163). The image and sectioning tracker 1181 may also determine the position of the surface of the specimen 1161 after sectioning to use as a reference in a next imaging and sectioning. An imaging controller 1173 causes the programmable stage 1167 to move the specimen 1161 to the sectioning device 1165 or causes a different programmable stage (not shown), in operative relationship with the sectioning device 1165, to move the sectioning device 1165 to the specimen 1161. The imaging controller 1173 may cause the programmable stage 1167 to image contiguous areas of the specimen 1161 with partial overlap and to cause the programmable stage 1167 to move in a cooperative manner with the sectioning device 1165 between imaging of the contiguous areas. The contiguous areas are contiguous in the X-, or Y-axes relative to the objective 1163 or in the Z-axis relative to the objective 1163. The imaging controller may also cause the programmable stage 1167 to repeat the imaging and sectioning a multiple number of times.

In FIG. 11D, a storage container 1175 is used to store sections removed from the specimen 1161 to enable a person or machine to identify aspects of the sections and generate a correlation of the aspects of the sections with images representing layers in the specimen 1161. A reporting unit 1179 is in communication with the storage container 1175 and reports the results of the correlation. The storage container 1175 is also connected to a staining unit 1177 that enables the person or machine to stain the sections removed from the specimen 1161 that were used to correlate the sections stored with the respective images of the sections.

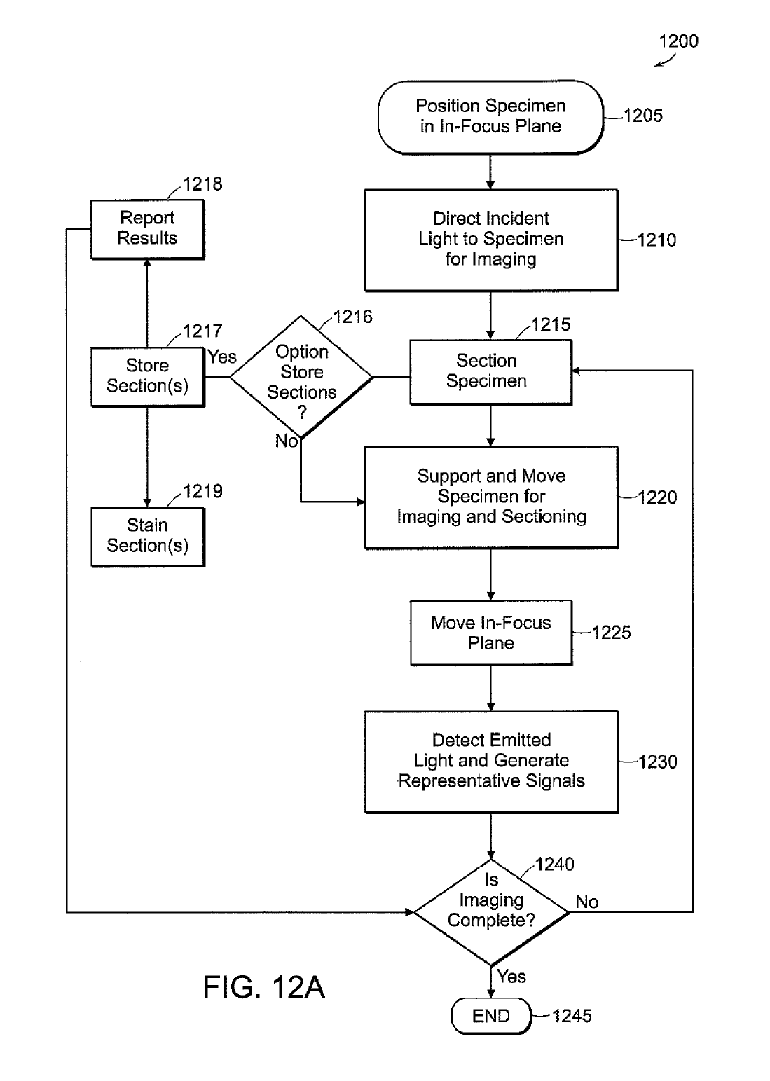

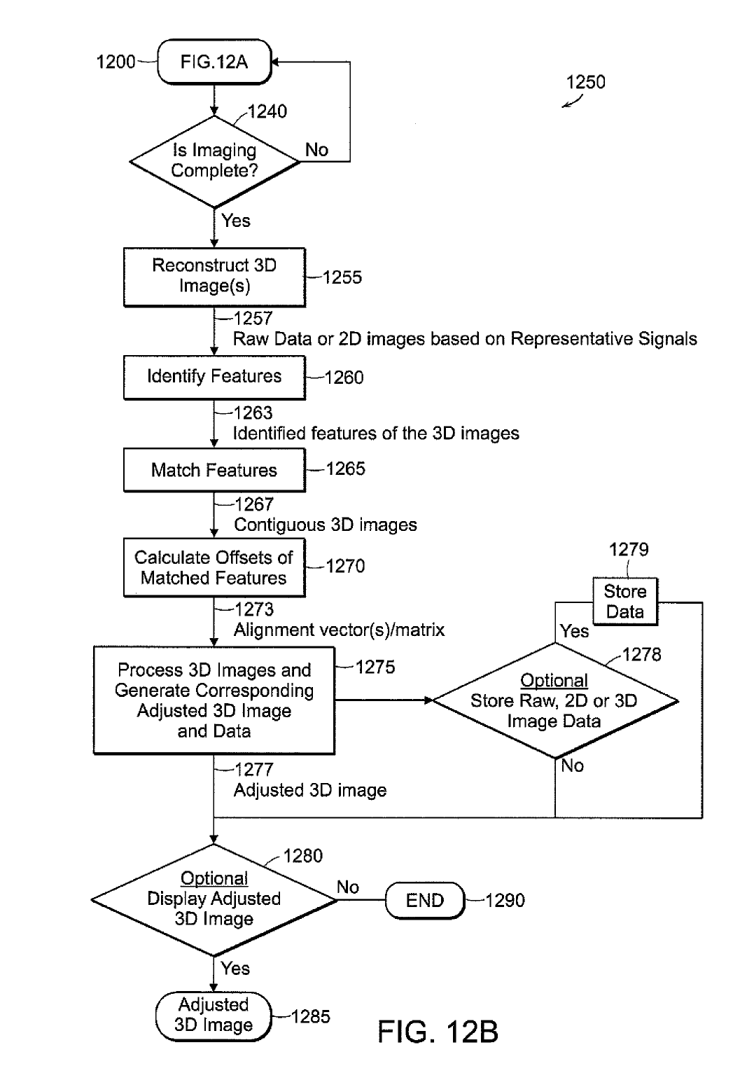

FIG. 12A is a block diagram illustrating an exemplary method 1200 that may be employed in accordance with an example embodiment of the present invention. In FIG. 12A, the specimen may be positioned 1205 in the in-focus plane of the objective and incident light from a light source may be directed 1210 to the specimen in the in-focus plane. The incident light will cause the specimen to emit light, which will be detected and used to generate signals representative of the detected emitted light to image the specimen. Next, the specimen may be sectioned 1215. The user has the option 1216 of storing sections of the specimen. If the storing sections option 1216 is selected, the sections are stored 1217 and may be used to identify aspects of the sections and generate a correlation of the aspects of the sections with images representing layers in the specimen. The results of the correlation may be reported 1218. The stored sections may also be stained 1219. Either after sectioning the specimen 1215 or storing the sections 1216, the specimen may be supported and moved 1220 using a programmable stage to allow for additional imaging and sectioning of the specimen. To do so, the in-focus plane of the objective may be moved 1225 to another location within the specimen and a sensor may be used 1230 to detect light emitted by the specimen in the in-focus plane and to generate signals representative of detected emitted light. After detecting 1230 the light emitted by the specimen and generating signals representative of detected emitted light or reporting 1218 results of the correlations, the imaging and sectioning of the specimen may cease 1245, if completed, or another section of the specimen may be removed 1215 and additional imaging and sectioning of the specimen may occur, as described above.

FIG. 12B provides additional details 1250 of the method 1200 illustrated in FIG. 12A in accordance with an example embodiment of the present invention. In FIG. 12B, if the imaging is not complete 1240, then the method 1200 illustrated in FIG. 12A may be repeated. If the imaging is complete 1240, multiple 3D images may be reconstructed 1255 using multiple sets of 2D images based on signals representative of the detected emitted light. Then, using raw data or 2D images based on representative signals 1257, features in the multiple 3D images may be identified 1260. Next, using the identified features of the 3D images 1263, features in contiguous 3D images are matched 1265. The contiguous 3D images 1267 are then used to calculate 1270 offsets of the matching features to generate an alignment vector or matrix. The alignment vector or matrix 1273 is then used to process 1275 the contiguous 3D images to generate adjusted data representing an adjusted 3D image 1277. After processing 1275 the 3D images, the user has the option 1278 to store 1279 the raw, 2D, or 3D image data. Additionally, the user has the option 1280 to display the adjusted 3D image 1285 or not 1290.

While this invention has been particularly shown and described with references to example embodiments thereof, it will be understood by those skilled in the art that various changes in form and details may be made therein without departing from the scope of the invention encompassed by the appended claims.

### EXEMPLIFICATIONS

Transgenic Mice. Mice that expressed cytoplasmic YFP under the neuron-specific Thyl promoter (YFP-H line) or both cyan fluorescent protein (CFP) and YFP (cross of CFP-S and YFP-H lines) were used for all experiments (protocol approved by the Faculty of Arts and Sciences' Institutional Animal Care and Use Committee, IACUC, at Harvard University. Adult and neonatal mice were anesthetized by subcutaneous injection of a mixture of ketamine and xylazine (17.39 mg/ml K, 2.61 mg/ml X; dose=0.1 ml/20 gms). For fixation of brain, mice were transcardially perfused with 3% paraformaldehyde. For fixation of muscle, mice were perfused with a mixture of 2% paraformaldehyde and 0.75% glutaraldehyde. The stronger fixation allowed muscle to be cut with minimal tearing. Brain was post-fixed for at least 3 hours before being removed from the skull. Muscle was surgically removed and post-fixed for 1 hour. The tissue was thoroughly rinsed in PBS (3 times, 15 minutes per rinse). Muscle was then incubated with alexa-647 conjugated α-bungarotoxin (2.5 micrograms per ml for 12 hrs at 4 C; Invitrogen) to label acetylcholine receptors and rinsed thoroughly with PBS. Finally the tissue was embedded in 8% low melting-temperature agarose, and the agarose block was attached to a polylysine-coated slide using super glue. Care was taken to keep the agarose hydrated with PBS to prevent shape changes due to drying.

Imaging. Tissue specimens were imaged using a multi-photon microscope system (FV 1000-MPE on a BX61 upright stand, Olympus America, Inc.) equipped with a precision XY stage (Prior) and a high-NA dipping cone objective (20x 0.95NA XLUMPFL20XW, Olympus America, Inc.). Image stacks were acquired from just below the cut surface of the block to a depth determined by light scattering properties of the fixed tissue, typically 50 microns to 100 microns for confocal imaging. The field of view was enlarged by acquiring tiled image stacks. The position of each image stack was controlled precisely by translating the block on the programmable microscope stage. The overlap between tiled stacks was typically 2%. The center coordinates of each image stack was recorded to allow repeat imaging of the same regions. CFP and YFP were excited with the 440 nm and 514 nm laser lines respectively. The receptor labeling was excited with 633 nm laser light. The channels were imaged sequentially.

Sectioning. Sections were cut by drawing the block under an oscillating-blade cutting tool, using the programmable stage to move the block relative to the cutting tool in a controlled and precise manner. The block was raised and lowered relative to the blade (High Profile 818 Blade, Leica Microsystems) by adjusting the microscope focus. The focus position was recorded after each slice. Section thickness was controlled by changing the focus (i.e., stage height) a known amount relative to the recorded position. The precision of the sectioning was determined by moving the block back under the objective and imaging the cut surface. The programmable stage made it straightforward to move back to the same region repeatedly. If the cutting speed was slow (approximately 3 min per 1 cm to 4 min per 1 cm), the sectioning was very consistent. Sections were cut reliably as thin as 25 microns. The cut surface was within 2 microns of the expected height. Blade chatter was roughly 2 microns to 4 microns for brain and 10 microns for muscle. The sections were typically discarded but could be collected for further analysis or processing if required.

Image Alignment. Large volumes were reconstructed seamlessly from image stacks that overlapped in X, Y and Z directions. After acquiring one set of tiled image stacks, a section was removed from the top surface of the block that was physically thinner than the depth that was just imaged. Structures that were imaged deep in the first set of image stacks were then re-imaged near the surface in the second set. This process of imaging and sectioning was repeated until all structures of interest were completely visualized. There was very little distortion as a result of sectioning; therefore, precision alignment was straightforward. Montages were created by stitching together the sets of tiled image stacks (overlapping in X and Y). A final 3D image was produced by merging the successive montages (overlapping in Z). The tiled stacks were aligned by identifying a structure that was present at an edge of two adjacent stacks in any image plane. The image stacks were merged by shifting one relative to the other in X and Y and discarding data from one or other stack where there was overlap. Successive montages were merged by discarding image planes from the bottom of the first montage that overlapped with the planes at the top of the next montage. The montages were then aligned by shifting the first plane of the second montage relative to the final plane of the first montage. The remaining planes of the second montage were aligned automatically by applying the same shift as for the first plane.

What is claimed is:

1. A system for generating a three-dimensional image of a specimen, comprising:
an objective configured to be spaced a distance from the specimen at which at least part of the specimen is within an in-focus plane of the objective;
optical elements configured (i) to direct incident light from at least one light source along an incident light path to multiple regions of the in-focus plane of the objective, the incident light causes the specimen at the in-focus plane of the objective to produce emitted light responsive to the incident light and (ii) to direct the emitted light along a return light path;
a sectioning device configured to section the specimen;
a programmable stage in an operative arrangement with the objective and sectioning device and configured to support and move the specimen (i) to the objective to image at least one area of the specimen and (ii) relative to the sectioning device to section the specimen in a cooperative manner with the sectioning device;
a programmable focus controller configured to change the distance between the objective and programmable stage to move the in-focus plane of the objective within the specimen; and
a sensor in optical communication with the return light path to detect the emitted light from the multiple regions of the in-focus plane of the objective and to generate signals representative of detected emitted light.

2. The system according to claim 1 wherein the programmable stage is configured to reposition the specimen relative to the objective to bring an area of the specimen previously outside a field of view of the objective to within the field of view of the objective.

3. The system according to claim 2 wherein the programmable stage is configured to reposition the specimen relative to the objective to produce partial overlap between three-dimensional images of contiguous areas of the specimen in at least one of two perpendicular dimensions.

4. The system according to claim 3 wherein the overlap is in at least one of the following axes: X-axis or Y-axis.

5. The system according to claim 1 wherein the programmable focus controller is configured to change the distance between the programmable stage and the sectioning device to define how much depth of the specimen is to be sectioned.

6. The system according to claim 5 wherein the programmable focus controller is further configured to section the specimen with a sectioning depth of less than an imaging depth to produce partial overlap in contiguous three-dimensional images of the same field of view before and after sectioning.

7. The system according to claim 1 wherein the programmable focus controller is configured to move the objective relative to the programmable stage, or the programmable stage relative to the objective, to change the distance between the objective and the specimen to bring more portions of the specimen within the in-focus plane of the objective.

8. The system according to claim 1 wherein the multiple regions of the in-focus plane of the objective are of a thickness substantially equal to a depth of field of the objective.

9. The system according to claim 1 further including an image and sectioning tracker to determine a distance and tilt between the in-focus plane of the objective and a sectioning plane of the sectioning device to support accurate imaging and sectioning.

10. The system according to claim 9 wherein the image and sectioning tracker is configured to determine the position of the surface of the specimen after sectioning to use as a reference in a next imaging and sectioning.

11. The system according to claim 1 further including an imaging controller configured to cause the objective to image contiguous areas of the specimen with partial overlap and to cause the programmable stage to move in a cooperative manner with the sectioning device to section the specimen between imaging of the contiguous areas.

12. The system according to claim 11 wherein the imaging controller is configured to cause the programmable stage to repeat the imaging and sectioning a multiple number of times.

13. The system according to claim 11 wherein the contiguous areas are contiguous in the X- or Y-axis relative to the objective.

14. The system according to claim 11 wherein the contiguous areas are contiguous in the Z-axis relative to the objective.

15. The system as claimed in claim 1 further comprising:
a reconstruction unit configured to reconstruct multiple three-dimensional images based upon multiple sets of two-dimensional images based on signals representative of the detected light;
an identification unit configured to identify features in the multiple three-dimensional images;
a feature matching unit configured to determine matching features in contiguous three-dimensional images;
an offset calculation unit configured to calculate offsets of the matching features to generate an alignment vector or matrix; and
a processing unit configured to process the contiguous three-dimensional images as a function of the alignment vectors or matrix to generate adjusted data representing an adjusted three-dimensional image.

16. The system as claimed in claim 15 further including a display unit configured to display the adjusted three-dimensional image.

17. The system as claimed in claim 1 further comprising a transmit unit configured to transmit data, representing two-dimensional images, representing layers of the specimen within the imaging depth of the objective, via a network to a reconstruction server to reconstruct a three-dimensional image of the specimen at a location in the network apart from the sensor.

18. The system as claimed in claim 17 further comprising a data storage unit configured to store data representing the two-dimensional or three-dimensional images.

19. The system as claimed in claim 1 wherein the sensor is further configured to detect light emitted by the specimen at select wavelengths of a spectrum of the emitted light.

20. The system as claimed in claim 1 wherein the sensor includes a detector selected from a group consisting of: a photo-multiplier tube (PMT) or a solid-state detector.

21. The system as claimed in claim 1 further including an imaging controller configured to cause the programmable stage to move the specimen to the sectioning device or to cause a different programmable stage, in operative relationship with the sectioning device, to move the sectioning device to the specimen.

22. The system as claimed in claim 1 further comprising:
a storage container configured to store sections removed from the specimen to enable a person or machine to identify aspects of the sections and generate a correlation of the aspects of the sections with images representing layers in the specimen; and
a reporting unit configured to report results of the correlation.

23. The system as claimed in claim 22 further comprising a staining unit configured to enable the person or machine to stain the sections removed from the specimen to correlate the sections stored with the respective images of the sections.

24. The system as claimed in claim 1 wherein the sectioning device is configured to oscillate a blade relative to a blade holder in a substantially uni-dimensional manner.

25. The system as claimed in claim 1 wherein the objective and programmable stage are components of a microscope selected from a group consisting of: an epifluorescence microscope, confocal microscope, or multi-photon microscope.

26. The system as claimed in claim 1 wherein the specimen is tissue selected from a group consisting of: a human, animal, or plant.

27. The system as claimed in claim 1 wherein the optical elements direct light to the multiple regions of the in-focus plane includes directing separate beams of incident light to the regions and the emitted light includes separate beams of emitted light corresponding to the specimen within the in-focus plane.

28. The system as claimed in claim 1 wherein the optical elements direct light to the multiple regions of the in-focus plane of the objective includes serially directing incident light to each region to illuminate separately the specimen within the multiple regions of the in-focus plane.

29. The system as set forth in claim 28 wherein the specimen is scanned with the incident light to illuminate sequentially the specimen within the multiple regions of the in-focus plane.

30. A method for generating a three-dimensional image of a specimen, comprising:
positioning at least part of the specimen to be within an in-focus plane of an objective through use of a programmable stage;
directing incident light along an incident light path to multiple regions of the in-focus plane, the incident light causing the specimen at the in-focus plane to produce emitted light responsive to the incident light;
directing the emitted light along a return light path to a sensor;
causing the programmable stage to operate in a cooperative manner with a sectioning device to section the specimen;
causing the programmable stage to operate in an operative arrangement with the objective and sectioning device to support and move the specimen to image at least one area of the specimen and to section the specimen;
changing a distance between the objective and programmable stage to move the in-focus plane within the specimen; and
detecting the emitted light from the multiple regions of the in-focus plane through the use of a sensor to generate signals representative of detected emitted light.

31. The method according to claim 30 further comprising causing the programmable stage to reposition the specimen relative to the objective to bring an area of the specimen previously outside a field of view of the objective to within the field of view of the objective.

32. The method according to claim 31 wherein repositioning the specimen causes partial overlap between three-dimensional images of contiguous areas of the specimen in at least one of two perpendicular dimensions.

33. The method according to claim 32 wherein the overlap is in at least one of the following axes: X-axis or Y-axis.

34. The method according to claim 30 further comprising causing the programmable stage to offset from the sectioning device in a dimension defining how much depth of the specimen is to be sectioned.

35. The method according to claim 34 wherein with the depth of the specimen to be sectioned is less than an imaging depth to produce partial overlap in contiguous three-dimensional images before and after sectioning.

36. The method according to claim 30 further comprising determining a distance and tilt between the in-focus plane and a sectioning plane of the sectioning device to support accurate imaging and sectioning.

37. The method according to claim 36 wherein the position of the surface of the specimen after sectioning is a reference in a next imaging and sectioning.

38. The method according to claim 36 further comprising causing the objective to image contiguous areas of the specimen with partial overlap and the programmable stage to move in a cooperative manner with the sectioning device to section the specimen between imaging of the contiguous areas.

39. The method according to claim 38 wherein the imaging and sectioning is repeated a multiple number of times.

40. The method according to claim 38 wherein the contiguous images are contiguous in an X- or Y-axis.

41. The method according to claim 38 wherein the contiguous images are contiguous in a Z-axis.

42. The method as claimed in claim 30 further comprising:
reconstructing multiple three-dimensional images based upon multiple sets of two-dimensional images based on signals representative of the detected emitted light;
identifying features in the multiple three-dimensional images;
matching features in contiguous three-dimensional images;
calculating offsets of the matching features to generate an alignment vector or matrix; and
processing the contiguous three-dimensional images as a function of the alignment vectors or matrix to generate adjusted data representing an adjusted three-dimensional image.

43. The method as claimed in claim 42 further comprising displaying the adjusted three-dimensional image.

44. The method as claimed in claim 30 further comprising transmitting data, representing two-dimensional images, representing layers of the specimen.

45. The method as claimed in claim 44 further comprising storing data representing the two-dimensional or three-dimensional images.

46. The method as claimed in claim 30 further comprising detecting light emitted by the specimen at select wavelengths of a spectrum of the emitted light.

47. The method as claimed in claim 30 wherein detecting the emitted light includes detecting photocharge generated in response to the emitted light with a detector either directly or after multiplying the photocharge or representation thereof.

48. The method as claimed in claim 30 further comprising:
storing sections removed from the specimen to enable a person or machine to identify aspects of the sections and generating a correlation of the aspects of the sections with images representing layers in the specimen; and
reporting results of the correlation.

49. The method as claimed in claim 48 further comprising staining the sections removed from the specimen to correlate the sections stored with the respective images of the sections.

50. The method as claimed in claim 30 further including imaging the specimen in accordance with microscopy selected from a group consisting of: epifluorescence microscopy, confocal microscopy, or multi-photon microscopy.

51. The method as claimed in claim 30 wherein the specimen is tissue selected from a group consisting of: a human, animal, or plant.

52. The method as claimed in claim 30 wherein directing light to the multiple regions of the in-focus plane includes directing separate beams of incident light to the regions and the emitted light includes separate beams of emitted light corresponding to the specimen within the in-focus plane.

53. The method as claimed in claim 30 wherein directing light to the multiple regions of the in-focus plane includes serially directing incident light to each region to illuminate separately the specimen within the multiple regions of the in-focus plane.

54. The method as set forth in claim 53 wherein directing the light to multiple regions of the in-focus plane includes scanning the specimen with the incident light to sequentially illuminate separate regions of the in-focus plane.

55. A method for providing data for healthcare, comprising:
generating a three-dimensional image of a specimen from a patient by reconstructing multiple two-dimensional images of layers of the specimen; and
transmitting data representing the three-dimensional image via a network to the patient or a person associated with the healthcare for the patient.

56. The method according to claim 55 wherein the patient is a human, animal, or plant.
